(19) United States
(12) Patent Application Publication
(10) Pub. No.: US 2019/0007699 A1
(43) Pub. Date: Jan. 3, 2019

(54) Decoder Side Motion Vector Derivation in Video Coding

(71) Applicant: Futurewei Technologies, Inc., Plano, TX (US)

(72) Inventors: Shan Liu, San Jose, CA (US); Wei Wang, San Jose, CA (US); Li Li, Kansas City, MO (US)

(21) Appl. No.: 16/020,144

(22) Filed: Jun. 27, 2018

Related U.S. Application Data
(60) Provisional application No. 62/526,242, filed on Jun. 28, 2017.
(60) Provisional application No. 62/544,039, filed on Aug. 11, 2017.

(51) Int. Cl. H04N 19/573; H04N 19/139; H04N 19/513; H04N 19/172

(52) U.S. Cl. CPC H04N 19/573; H04N 19/172; H04N 19/513; H04N 19/139

(57) ABSTRACT

A video decoder obtains a preceding reference frame and a subsequent reference frame. A motion vector between the preceding reference frame the subsequent reference frame is determined. The motion vector includes a preceding motion vector (MV0) between a current frame and the preceding reference frame and a subsequent motion vector (MV1) between the current frame and the subsequent reference frame. A non-continuous motion trajectory of a current coding object between the preceding reference frame and the subsequent reference frame is derived. A subsequent search window is set in an area pointed to by MV1. A set of refined subsequent motion vectors (MV1′) are determined that point into the subsequent search window. Differences are determined between subsequent reference blocks pointed to by the MV1′ and a preceding reference block pointed to by the MV0. The MV1′ vector with a smallest difference as is set as an updated MV1.

### CROSS-REFERENCE TO RELATED APPLICATIONS

This patent application claims the benefit of U.S. Provisional Patent Application No. 62/526,242, filed Jun. 28, 2017, by Shan Liu, et al., and titled “Decoder Side Motion Vector Derivation in Video Coding,” and of U.S. Provisional Patent Application No. 62/544,039, filed Aug. 11, 2017, by Shan Liu, et al., and titled “Decoder Side Motion Vector Derivation in Video Coding,” which are hereby incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in image quality are desirable.

### SUMMARY

In an embodiment, the disclosure includes a method implemented in a video decoder. the method comprises generating, by a processor, a plurality of reference frames from a bitstream, the reference frames including a preceding reference frame and a subsequent reference frame; determining, by the processor, a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; determining, by the processor, a non-continuous motion trajectory of a current coding object between the preceding coding object and the subsequent coding object by: setting a subsequent search window to encompass an area of the subsequent reference frame pointed to by MV1, determining a set of refined subsequent motion vectors (MV1′) pointing into the subsequent search window, determining differences between subsequent reference blocks pointed to by the MV1′ and a preceding reference block pointed to by the MV0, and setting an MV1′ vector with a smallest difference as an updated MV1; and generating, by the processor, a video stream for display on a display screen, the video stream including a current frame, the current frame containing the current coding object in a position determined according to the non-continuous motion trajectory based on the updated MV1 and the MV0.

Optionally, in any of the preceding aspects, another implementation of the aspect includes, wherein the non-continuous motion trajectory is not signaled in the bitstream.

Optionally, in any of the preceding aspects, another implementation of the aspect includes, wherein the differences are determined according to a sum of absolute differences (SAD), a sum of absolute transformed difference (SAID), a mean square error (MSE), or combinations thereof.

Optionally, in any of the preceding aspects, another implementation of the aspect includes, wherein determining the non-continuous motion trajectory of the current coding object further includes: setting a preceding search window to encompass an area of the preceding reference frame pointed to by MV0, determining a set of refined preceding motion vectors (MV0′) pointing into the preceding search window, determining differences between preceding reference blocks pointed to by MV0′ and a subsequent reference block pointed to by the updated MV1, setting an MV0′ vector with a smallest difference as an updated MV0, and wherein non-continuous motion trajectory is further determined based on the updated MV0.

Optionally, in any of the preceding aspects, another implementation of the aspect includes, wherein the motion vector including MV1 and MV0 is selected from a list of continuous motion trajectory candidate vectors generated when determining an initial motion vector to position a coding unit (CU) based on bilateral matching or template matching.

Optionally, in any of the preceding aspects, another implementation of the aspect includes, wherein the motion vector including MV1 and MV0 is selected as part of a local search during refinement of an initial motion vector to position a coding unit (CU) based on bilateral matching or template matching.

Optionally, in any of the preceding aspects, another implementation of the aspect includes, wherein the motion vector including MV1 and MV0 is selected as part of a sub-coding unit (CU) refinement based on an initial motion vector to position a coding unit (CU).

Optionally, in any of the preceding aspects, another implementation of the aspect includes, wherein the differences between the subsequent reference blocks pointed to by the MV1′ and the preceding reference block pointed to by the MV0 are further determined according to bilinear interpolation or eight-tap High Efficiency Video Coding (HEVC) interpolation.

Optionally, in any of the preceding aspects, another implementation of the aspect includes, wherein MV0 is determined from a merge candidate list signaled in the bitstream.

Optionally, in any of the preceding aspects, another implementation of the aspect includes, wherein MV0 is signaled in the bitstream as a motion vector predictor (MVP) and an associated motion vector difference (MVD).

In an embodiment, the disclosure includes a method implemented in a video decoder. The method comprises generating, by a processor, a plurality of reference frames from a bitstream, the reference frames including a preceding reference frame and a subsequent reference frame; determining, by the processor, a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; determining, by the processor, a non-continuous motion trajectory of a current coding object between the preceding coding object and the subsequent coding object by: setting a preceding search window to encompass an area of the preceding reference frame pointed to by MV0, determining a set of refined preceding motion vectors (MV0′) pointing into the preceding search window, determining differences between preceding reference blocks pointed to by the MV0′ and a subsequent reference block pointed to by the MV1, and setting an MV0′ vector with a smallest difference as an updated MV0; and generating, by the processor, a video stream for display on a display screen, the video stream including a current frame, the current frame containing the current coding object in a position determined according to the non-continuous motion trajectory based on the updated MV0 and the MV1.

Optionally, in any of the preceding aspects, another implementation of the aspect includes, wherein the motion vector including MV1 and MV0 is selected from a list of continuous motion trajectory candidate vectors generated when determining an initial motion vector to position a coding unit (CU) based on bilateral matching or template matching.

Optionally, in any of the preceding aspects, another implementation of the aspect includes, wherein the motion vector including MV1 and MV0 is selected as part of a local search during refinement of an initial motion vector to position a coding unit (CU) based on bilateral matching or template matching.

Optionally, in any of the preceding aspects, another implementation of the aspect includes, wherein the motion vector including MV1 and MV0 is selected as part of a sub-coding unit (CU) refinement based on an initial motion vector to position a coding unit (CU).

Optionally, in any of the preceding aspects, another implementation of the aspect includes, wherein MV1 is determined from a merge candidate list signaled in the bitstream.

In an embodiment, the disclosure includes a video coding device comprising: a receiver configured to receive a bitstream including a plurality of coded reference frames, the reference frames including a preceding reference frame and a subsequent reference frame; a processor coupled to the receiver, the processor configured to: determine a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; determine a non-continuous motion trajectory of a current coding object between the preceding coding object and the subsequent coding object by: setting a subsequent search window to encompass an area of the subsequent reference frame pointed to by MV1, determining a set of refined subsequent motion vectors (MV1′) pointing into the subsequent search window, setting a preceding search window to encompass an area of the preceding reference frame pointed to by MV0, determining a set of refined preceding motion vectors (MV0′) pointing into the preceding search window, determining differences between subsequent reference blocks pointed to by the MV1′ and preceding reference blocks pointed to by the MV0′ for vector pairs including a vector from MV1′ and a vector from MV0′, and setting a vector pair with a smallest difference as an updated MV1 and an updated MV0; and generate a video stream for display on a display screen, the video stream including a current frame, the current frame containing the current coding object in a position determined according to the non-continuous motion trajectory based on the updated MV1 and the updated MV0.

Optionally, in any of the preceding aspects, another implementation of the aspect includes, wherein the non-continuous motion trajectory is not signaled in the bitstream.

Optionally, in any of the preceding aspects, another implementation of the aspect includes, wherein the motion vector including MV1 and MV0 is selected from a list of continuous motion trajectory candidate vectors generated when determining an initial motion vector to position a coding unit (CU) based on bilateral matching or template matching.

Optionally, in any of the preceding aspects, another implementation of the aspect includes, wherein the motion vector including MV1 and MV0 is selected as part of a local search during refinement of an initial motion vector to position a coding unit (CU) based on bilateral matching or template matching.

Optionally, in any of the preceding aspects, another implementation of the aspect includes, wherein the motion vector including MV1 and MV0 is selected as part of a sub-coding unit (CU) refinement based on an initial motion vector to position a coding unit (CU).

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a flowchart of an example method of coding a video signal.

FIG. 2 is a schematic diagram of an example coding and decoding (codec) system for video coding.

FIG. 3 is a schematic diagram illustrating an example video decoder that may implement inter-prediction.

FIG. 4 is a flowchart of an example method of deriving a motion vector (MV) for continuous motion trajectory in inter-prediction.

FIG. 5 is a schematic diagram illustrating an example of bilateral matching in inter-prediction.

FIG. 6 is a schematic diagram illustrating an example of template matching in inter-prediction.

FIG. 7 is a schematic diagram illustrating an example mechanism for deriving a non-continuous motion trajectory at a decoder by refining a subsequent motion vector (MV1).

FIG. 8 is a schematic diagram illustrating an example mechanism for deriving a non-continuous motion trajectory at a decoder by refining a preceding motion vector (MV0) and MV1.

FIG. 9 is a schematic diagram illustrating an example mechanism for deriving a non-continuous motion trajectory at a decoder by determining refined MV0 and MV1 pairs.

FIG. 10 is a schematic diagram of an example video coding device.

FIG. 11 is a flowchart of an example method of video decoding by deriving a non-continuous motion trajectory at a decoder by refining MV0 and/or MV1.

FIG. 12 is a flowchart of an example method of video decoding by deriving a non-continuous motion trajectory at a decoder by determining refined MV0 and MV1 pairs.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Video coding involves a combination of compression by inter-prediction and intra-prediction. The present disclosure focuses on increasing the coding efficiency of inter-prediction, which is a mechanism to encode the position of an object in a frame based on the position of the object in a different frame. For example, inter-prediction is employed when a coding object, such as a coding tree unit (CTU), a coding tree block (CTB), a coding unit (CU), a sub-CU, etc., appears in multiple frames of a video sequence. Rather than coding the same object in each frame, the object is coded in a reference frame and a motion vector (MV) is employed to indicate a motion trajectory of an object. The motion trajectory of an object is the object's movement over time. An MV is a vector that indicates a direction and magnitude of an objects change in position between frames. The object and the MV can be coded in a bitstream and decoded by a decoder. In an effort to further increase coding efficiency and reduce the size of the encoding, the MV may be omitted from the bitstream and derived at the decoder. For example, a pair of reference frames may be employed. A reference frame is a frame in a bitstream that includes data that can be coded by reference when coding related frames. Matching algorithms, such as bi-lateral matching and/or template matching may be employed to determine the position of the coding object in both reference frames. A bi-lateral matching algorithm matches a block in a previous frame to a block in a current frame. A template matching algorithm matches adjacent blocks to a current block with adjacent blocks to the current block in one or more reference frames. Once the position of the object is determined in both reference frames, an MV can be determined that represents the motion of the object between the reference frames. The MV can then be employed to position the object in the frames between the reference frames. As a specific example, an initial MV can be determined for an entire CU. A local search can then be employed to refine the initial MV. Further, MVs for sub-CU components of the object can be determined and refined based on the refined initial MV. Such an approach indicates the correct position of the object so long as the motion trajectory of the object is continuous between the reference frames.

Disclosed herein are mechanisms to derive a position of a coding object at a decoder even when the motion trajectory of the object is non-continuous between the reference frames. As used herein a motion trajectory is non-continuous when the motion of an object is non-linear (e.g., not straight) over time as depicted in a sequence of video frames. The disclosed mechanisms can be employed to modify an initial MV for a CU, a refined MV for the CU, an initial or refined MV for a sub-CU component, or combinations thereof, for a non-continuous motion trajectory of a coding object. The relevant MV is obtained and converted into a preceding motion vector (MV0) that points from a current frame to a preceding object in a preceding reference frame and into a subsequent motion vector (MV1) that points from the current frame to a subsequent object in a subsequent reference frame. Initially, MV0 and MV1 point in a continuous motion trajectory. MV0 and MV1 are then refined to adjust for a non-continuous motion trajectory. In one example, a search window is drawn around an area of the subsequent reference frame pointed to by MV1 (e.g., around a block). A set of refined subsequent motion vectors (MV1′) are generated that point into the search window. The block pointed to by MV0 is compared to the blocks pointed to by MV1′, and the vector in MV1′ with the best match (e.g., least difference) is selected as an updated MV1. In another example, a similar process is performed by generating a set of refined preceding motion vectors (MV0′) that point into a search widow around an area in the preceding reference frame. The block pointed to by MV1 is compared to the blocks pointed to by MV0′, and the vector in MV0′ with the best match (e.g., least difference) is selected as an updated MV0. In yet another example, MV1 is updated by the process described above and the updated MV1 is employed to update MV0 by the process described above. Accordingly, MV1 and MV0 can be iteratively updated based on each other up to a predefined number of iterations and/or until differences in match values over successive iterations drop below a threshold. In yet another example, a set of MV0′ and a set of MV1′ are generated. The vectors in MV0′ are paired with various combinations of vectors in MV1′. The pair with the best match (e.g., the least difference) is selected as the updated MV0 and MV1. In some examples, MV1 or MV0, but not both, are signaled in a merge list. The motion vector that is not signaled is then determined according to one of the examples above based on the signaled motion vector.

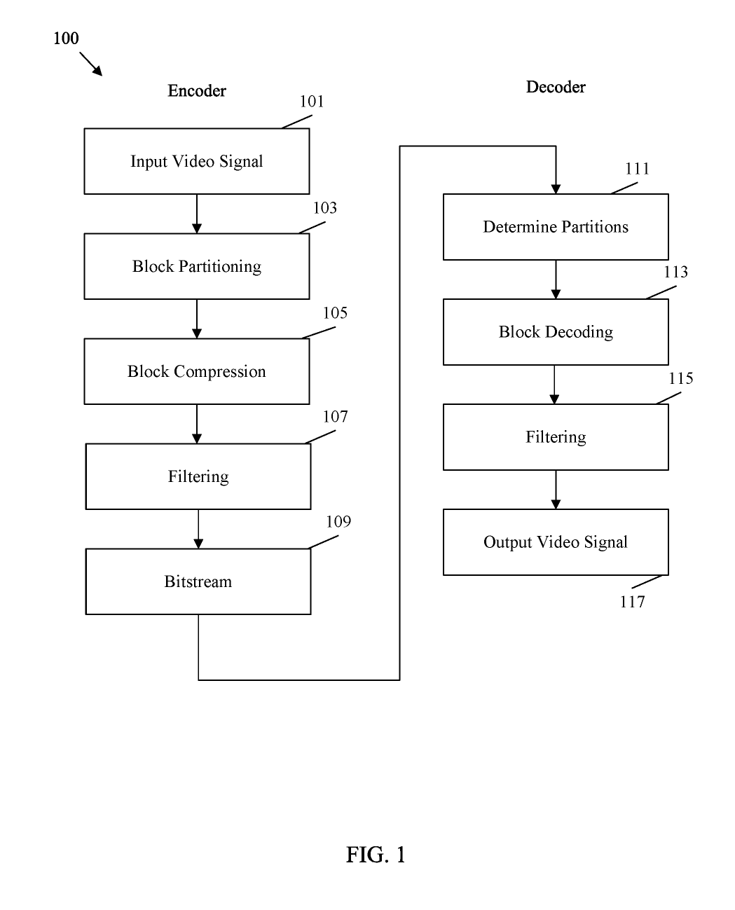

FIG. 1 is a flowchart of an example method 100 of coding a video signal. Specifically, a video signal is encoded at an encoder. The encoding process compresses the video signal by employing various mechanisms to reduce the video file size. A smaller file size allows the compressed video file to be transmitted toward a user, while reducing associated bandwidth overhead. The decoder then decodes the compressed video file to reconstruct the original video signal for display to an end user. The decoding process generally mirrors the encoding process to allow the decoder to consistently reconstruct the video signal.

At step 101, the video signal is input into the encoder. For example, the video signal may be an uncompressed video file stored in memory. As another example, the video file may be captured by a video capture device, such as a video camera, and encoded to support live streaming of the video. The video file may include both an audio component and a video component. The video component contains a series of image frames that, when viewed in a sequence, gives the visual impression of motion. The frames contain pixels that are expressed in terms of light, referred to herein as luma components, and color, which is referred to as chroma components. In some examples, the frames may also contain depth values to support three dimensional viewing.

At step 103, the video is partitioned into blocks. Partitioning includes subdividing the pixels in each frame into square and/or rectangular blocks for compression. For example, coding trees may be employed to divide and then recursively subdivide blocks until configurations are achieved that support further encoding. As such, the blocks may be referred to as coding tree units in High Efficiency Video Coding (HEVC) (also known as H.265 and MPEG-H Part 2). For example, luma components of a frame may be subdivided until the individual blocks contain relatively homogenous lighting values. Further, chroma components of a frame may be subdivided until the individual blocks contain relatively homogenous color values. Accordingly, partitioning mechanisms vary depending on the content of the video frames.

At step 105, various compression mechanisms are employed to compress the image blocks partitioned at step 103. For example, inter-prediction and/or intra-prediction may be employed. Inter-prediction is designed to take advantage of the fact that objects in a common scene tend to appear in successive frames. Accordingly, a block depicting an object in a reference frame need not be repeatedly described in adjacent frames. Specifically, an object, such as a table, may remain in a constant position over multiple frames. Hence the table is described once and adjacent frames can refer back to the reference frame. Pattern matching mechanisms may be employed to match objects over multiple frames. Further, moving objects may be represented across multiple frames, for example due to object movement or camera movement. As a particular example, a video may show an automobile that moves across the screen over multiple frames. Motion vectors can be employed to describe such movement. A motion vector is a two-dimensional vector that provides an offset from the coordinates of an object in a frame to the coordinates of the object in a reference frame. As such, inter-prediction can encode an image block in a current frame as a set of motion vectors indicating an offset from a corresponding block in a reference frame.

Intra-prediction encodes blocks in a common frame. Intra-prediction takes advantage of the fact that luma and chroma components tend to cluster in a frame. For example, a patch of green in a portion of a tree tends to be positioned adjacent to similar patches of green. Intra-prediction employs multiple directional prediction modes (e.g., thirty three in HEVC), a planar mode, and a direct current (DC) mode. The directional modes indicate that a current block is similar/the same as samples of a neighbor block in a corresponding direction. Planar mode indicates that a series of blocks along a row/column (e.g., a plane) can be interpolated based on neighbor blocks at the edges of the row. Planar mode, in effect, indicates a smooth transition of light/color across a row/column by employing a relatively constant slope in changing values. DC mode is employed for boundary smoothing and indicates that a block is similar/the same as an average value associated with samples of all the neighbor blocks associated with the angular directions of the directional prediction modes. Accordingly, intra-prediction blocks can represent image blocks as various relational prediction mode values instead of the actual values. Further, inter-prediction blocks can represent image blocks as motion vector values instead of the actual values. In either case, the prediction blocks may not exactly represent the image blocks in some cases. Any differences are stored in residual blocks. Transforms may be applied to the residual blocks to further compress the file.

At step 107, various filtering techniques may be applied. In HEVC, the filters are applied according to an in-loop filtering scheme. The block based prediction discussed above may result in the creation of blocky images at the decoder. Further, the block based prediction scheme may encode a block and then reconstruct the encoded block for later use as a reference block. The in-loop filtering scheme iteratively applies noise suppression filters, de-blocking filters, adaptive loop filters, and sample adaptive offset (SAO) filters to the blocks/frames. These filters mitigate such blocking artefacts so that the encoded file can be accurately reconstructed. Further, these filters mitigate artefacts in the reconstructed reference blocks so that artefacts are less likely to create additional artefacts in subsequent blocks that are encoded based on the reconstructed reference blocks.

Once the video signal has been partitioned, compressed, and filtered, the resulting data is encoded in a bitstream at step 109. The bitstream includes the data discussed above as well as any signaling data desired to support proper video signal reconstruction at the decoder. For example, such data may include partition data, prediction data, residual blocks, and various flags providing coding instructions to the decoder. The bitstream may be stored in memory for transmission toward a decoder upon request. The bitstream may also be broadcast and/or multicast toward a plurality of decoders. The creation of the bitstream is an iterative process. Accordingly, steps 101, 103, 105, 107, and 109 may occur continuously and/or simultaneously over many frames and blocks. The order shown in FIG. 1 is presented for clarity and ease of discussion, and is not intended to limit the video coding process to a particular order.

The decoder receives the bitstream and begins the decoding process at step 111. Specifically, the decoder employs an entropy decoding scheme to convert the bitstream into corresponding syntax and video data. The decoder employs the syntax data from the bitstream to determine the partitions for the frames at step 111. The partitioning should match the results of block partitioning at step 103. Entropy encoding/decoding as employed in step 111 is now described. The encoder makes many choices during the compression process, such as selecting block partitioning schemes from several possible choices based on the spatial positioning of values in the input image(s). Signaling the exact choices may employ a large number of bins. As used herein, a bin is a binary value that is treated as variable (e.g., a bit value that may vary depending on context). Entropy coding allows the encoder to discard any options that are clearly not viable for a particular case, leaving a set of allowable options. Each allowable option is then assigned a code word. The length of the code words is based on the number of allowable options (e.g., one bin for two options, two bins for three to four options, etc.) The encoder then encodes the code word for the selected option. This scheme reduces the size of the code words as the code words are as big as desired to uniquely indicate a selection from a small sub-set of allowable options as opposed to uniquely indicating the selection from a potentially large set of all possible options. The decoder then decodes the selection by determining the set of allowable options in a similar manner to the encoder. By determining the set of allowable options, the decoder can read the code word and determine the selection made by the encoder.

At step 113, the decoder performs block decoding. Specifically, the decoder employs reverse transforms to generate residual blocks. Then the decoder employs the residual blocks and corresponding prediction blocks to reconstruct the image blocks according to the partitioning. The prediction blocks may include both intra-prediction blocks and inter-prediction blocks as generated at the encoder at step 105. The reconstructed image blocks are then positioned into frames of a reconstructed video signal according to the partitioning data determined at step 111. Syntax for step 113 may also be signaled in the bitstream via entropy coding as discussed above.

At step 115, filtering is performed on the frames of the reconstructed video signal in a manner similar to step 107 at the encoder. For example, noise suppression filters, de-blocking filters, adaptive loop filters, and SAO filters may be applied to the frames to remove blocking artefacts. Once the frames are filtered, the video signal can be output to a display at step 117 for viewing by an end user.

The present disclosure relates to deriving MVs at the decoder to describe non-continuous motion of encoded objects between frames without completely signaling such MVs from the encoder to the decoder in the bitstream. Hence, the motion vector derivation mechanisms described in the FIGS. below impact the operation of block compression at step 105, encoding the data stream at step 109, and block decoding at step 113.

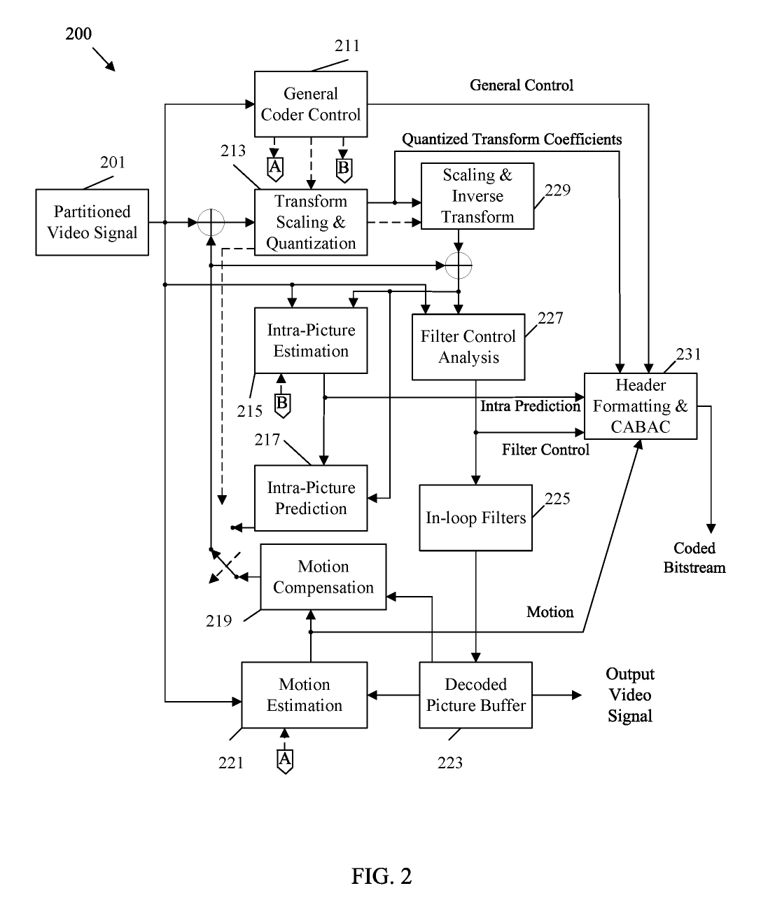

FIG. 2 is a schematic diagram of an example coding and decoding (codec) system 200 for video coding. Specifically, codec system 200 provides functionality to support the implementation of method 100. Codec system 200 is generalized to depict components employed in both an encoder and a decoder. Codec system 200 receives and partitions a video signal as discussed with respect to steps 101 and 103 in method 100, which results in a partitioned video signal 201. Codec system 200 then compresses the partitioned video signal 201 into a coded bitstream when acting as an encoder as discussed with respect to steps 105, 107, and 109 in method 100. When acting as a decoder codec system 200 generates an output video signal from the bitstream as discussed with respect to steps 111, 113, 115, and 117 in method 100. The codec system 200 includes a general coder control component 211, a transform scaling and quantization component 213, an intra-picture estimation component 215, an intra-picture prediction component 217, a motion compensation component 219, a motion estimation component 221, a scaling and inverse transform component 229, a filter control analysis component 227, an in-loop filter component 225, a decoded picture buffer 223, and a header formatting and Context adaptive binary arithmetic coding (CABAC) component 231. Such components are coupled as shown. In FIG. 2, black lines indicate movement of data to be encoded/decoded while dashed lines indicate movement of control data that controls the operation of other components. The components of codec system 200 may all be present in the encoder. The decoder may include a subset of the components of codec system 200. For example, the decoder may include the intra-picture prediction component 217, the motion compensation component 219, the scaling and inverse transform component 229, the in-loop filters component 225, and the decoded picture buffer 223. These components are now described.

The partitioned video signal 201 is a captured video stream that has been partitioned into blocks of pixels by a coding tree. A coding tree employs various split modes to subdivide a block of pixels into smaller blocks of pixels. These blocks can then be further subdivided into smaller blocks. The blocks may be referred to as nodes on the coding tree. Larger parent nodes are split into smaller child nodes. The number of times a node is subdivided is referred to as the depth of the node/coding tree. The divided blocks are referred to as coding units (CUs) in some cases. The split modes may include a binary tree (BT), triple tree (TT), and a quad tree (QT) employed to partition a node into two, three, or four child nodes, respectively, of varying shapes depending on the split modes employed. The partitioned video signal 201 is forwarded to the general coder control component 211, the transform scaling and quantization component 213, the intra-picture estimation component 215, the filter control analysis component 227, and the motion estimation component 221 for compression.

The general coder control component 211 is configured to make decisions related to coding of the images of the video sequence into the bitstream according to application constraints. For example, the general coder control component 211 manages optimization of bitrate/bitstream size versus reconstruction quality. Such decisions may be made based on storage space/bandwidth availability and image resolution requests. The general coder control component 211 also manages buffer utilization in light of transmission speed to mitigate buffer underrun and overrun issues. To manage these issues, the general coder control component 211 manages partitioning, prediction, and filtering by the other components. For example, the general coder control component 211 may dynamically increase compression complexity to increase resolution and increase bandwidth usage or decrease compression complexity to decrease resolution and bandwidth usage. Hence, the general coder control component 211 controls the other components of codec system 200 to balance video signal reconstruction quality with bit rate concerns. The general coder control component 211 creates control data, which controls the operation of the other components. The control data is also forwarded to the header formatting and CABAC component 231 to be encoded in the bitstream to signal parameters for decoding at the decoder.

The partitioned video signal 201 is also sent to the motion estimation component 221 and the motion compensation component 219 for inter-prediction. A frame or slice of the partitioned video signal 201 may be divided into multiple video blocks. Motion estimation component 221 and the motion compensation component 219 perform inter-predictive coding of the received video block relative to one or more blocks in one or more reference frames to provide temporal prediction. Codec system 200 may perform multiple coding passes, e.g., to select an appropriate coding mode for each block of video data.

Motion estimation component 221 and motion compensation component 219 may be highly integrated, but are illustrated separately for conceptual purposes. Motion estimation, performed by motion estimation component 221, is the process of generating motion vectors, which estimate motion for video blocks. A motion vector, for example, may indicate the displacement of a coded object relative to a predictive block. A predictive block is a block that is found to closely match the block to be coded, in terms of pixel difference. Such pixel difference may be determined by sum of absolute difference (SAD), sum of square difference (SSD), or other difference metrics. HEVC employs several coded objects including a CTU, CTBs, and CUs. For example, a CTU can be divided into CTBs, which can then be divided into CUs, which can be further sub-divided as desired. A CU can be encoded as a prediction unit (PU) containing prediction data and/or a transform unit (Tu) containing transformed residual data for the CU.

In some examples, codec system 200 may calculate values for sub-integer pixel positions of reference pictures stored in decoded picture buffer 223. For example, video codec system 200 may interpolate values of one-quarter pixel positions, one-eighth pixel positions, or other fractional pixel positions of the reference picture. Therefore, motion estimation component 221 may perform a motion search relative to the full pixel positions and fractional pixel positions and output a motion vector with fractional pixel precision. The motion estimation component 221 calculates a motion vector for a PU of a video block in an inter-coded slice by comparing the position of the PU to the position of a predictive block of a reference picture. Motion estimation component 221 outputs the calculated motion vector as motion data to header formatting and CABAC component 231 for encoding and motion to the motion compensation component 219.

Motion compensation, performed by motion compensation component 219, may involve fetching or generating the predictive block based on the motion vector determined by motion estimation component 221. Again, motion estimation component 221 and motion compensation component 219 may be functionally integrated, in some examples. Upon receiving the motion vector for the PU of the current video block, motion compensation component 219 may locate the predictive block to which the motion vector points a reference picture list. A residual video block is then formed by subtracting pixel values of the predictive block from the pixel values of the current video block being coded, forming pixel difference values. In general, motion estimation component 221 performs motion estimation relative to luma components, and motion compensation component 219 uses motion vectors calculated based on the luma components for both chroma components and luma components. The predictive block and residual block are forwarded to transform scaling and quantization component 213.

The partitioned video signal 201 is also sent to intra-picture estimation component 215 and intra-picture prediction component 217. As with motion estimation component 221 and motion compensation component 219, intra-picture estimation component 215 and intra-picture prediction component 217 may be highly integrated, but are illustrated separately for conceptual purposes. The intra-picture estimation component 215 and intra-picture prediction component 217 intra-predict a current block relative to blocks in a current frame, as an alternative to the inter-prediction performed by motion estimation component 221 and motion compensation component 219 between frames, as described above. In particular, the intra-picture estimation component 215 determines an intra-prediction mode to use to encode a current block. In some examples, intra-picture estimation component 215 selects an appropriate intra-prediction mode to encode a current block from multiple tested intra-prediction modes. The selected intra-prediction modes are then forwarded to the header formatting and CABAC component 231 for encoding.

For example, the intra-picture estimation component 215 calculates rate-distortion values using a rate-distortion analysis for the various tested intra-prediction modes, and selects the intra-prediction mode having the best rate-distortion characteristics among the tested modes. Rate-distortion analysis generally determines an amount of distortion (or error) between an encoded block and an original unencoded block that was encoded to produce the encoded block, as well as a bitrate (e.g., a number of bits) used to produce the encoded block. The intra-picture estimation component 215 calculates ratios from the distortions and rates for the various encoded blocks to determine which intra-prediction mode exhibits the best rate-distortion value for the block. In addition, intra-picture estimation component 215 may be configured to code depth blocks of a depth map using a depth modeling mode (DMM) based on rate-distortion optimization (RDO).

The intra-picture prediction component 217 may generate a residual block from the predictive block based on the selected intra-prediction modes determined by intra-picture estimation component 215 when implemented on an encoder or read the residual block from the bitstream when implemented on a decoder. The residual block includes the difference in values between the predictive block and the original block, represented as a matrix. The residual block is then forwarded to the transform scaling and quantization component 213. The intra-picture estimation component 215 and the intra-picture prediction component 217 may operate on both luma and chroma components.

The transform scaling and quantization component 213 is configured to further compress the residual block. The transform scaling and quantization component 213 applies a transform, such as a discrete cosine transform (DCT), a discrete sine transform (DST), or a conceptually similar transform, to the residual block, producing a video block comprising residual transform coefficient values. Wavelet transforms, integer transforms, sub-band transforms or other types of transforms could also be used. The transform may convert the residual information from a pixel value domain to a transform domain, such as a frequency domain. The transform scaling and quantization component 213 is also configured to scale the transformed residual information, for example based on frequency. Such scaling involves applying a scale factor to the residual information so that different frequency information is quantized at different granularities, which may affect final visual quality of the reconstructed video. The transform scaling and quantization component 213 is also configured to quantize the transform coefficients to further reduce bit rate. The quantization process may reduce the bit depth associated with some or all of the coefficients. The degree of quantization may be modified by adjusting a quantization parameter. In some examples, the transform scaling and quantization component 213 may then perform a scan of the matrix including the quantized transform coefficients. The quantized transform coefficients are forwarded to the header formatting and CABAC component 231 to be encoded in the bitstream.

The scaling and inverse transform component 229 applies a reverse operation of the transform scaling and quantization component 213 to support motion estimation. The scaling and inverse transform component 229 applies inverse scaling, transformation, and/or quantization to reconstruct the residual block in the pixel domain, e.g., for later use as a reference block which may become a predictive block for another current block. The motion estimation component 221 and/or motion compensation component 219 may calculate a reference block by adding the residual block back to a corresponding predictive block for use in motion estimation of a later block/frame. Filters are applied to the reconstructed reference blocks to mitigate artefacts created during scaling, quantization, and transform. Such artefacts could otherwise cause inaccurate prediction (and create additional artefacts) when subsequent blocks are predicted.

The filter control analysis component 227 and the in-loop filters component 225 apply the filters to the residual blocks and/or to reconstructed image blocks. For example, the transformed residual block from scaling and inverse transform component 229 may be combined with a corresponding prediction block from intra-picture prediction component 217 and/or motion compensation component 219 to reconstruct the original image block. The filters may then be applied to the reconstructed image block. In some examples, the filters may instead be applied to the residual blocks. As with other components in FIG. 2, the filter control analysis component 227 and the in-loop filters component 225 are highly integrated and may be implemented together, but are depicted separately for conceptual purposes. Filters applied to the reconstructed reference blocks are applied to particular spatial regions and include multiple parameters to adjust how such filters are applied. The filter control analysis component 227 analyzes the reconstructed reference blocks to determine where such filters should be applied and sets corresponding parameters. Such data is forwarded to the header formatting and CABAC component 231 as filter control data for encoding. The in-loop filters component 225 applies such filters based on the filter control data. The filters may include a deblocking filter, a noise suppression filter, a SAO filter, and an adaptive loop filter. Such filters may be applied in the spatial/pixel domain (e.g., on a reconstructed pixel block) or in the frequency domain, depending on the example.

When operating as an encoder, the filtered reconstructed image block, residual block, and/or prediction block are stored in the decoded picture buffer 223 for later use in motion estimation as discussed above. When operating as a decoder, the decoded picture buffer 223 stores and forwards the reconstructed and filtered blocks toward a display as part of an output video signal. The decoded picture buffer 223 may be any memory device capable of storing prediction blocks, residual blocks, and/or reconstructed image blocks.

The header formatting and CABAC component 231 receives the data from the various components of codec system 200 and encodes such data into a coded bitstream for transmission toward a decoder. Specifically, the header formatting and CABAC component 231 generates various headers to encode control data, such as general control data and filter control data. Further, prediction data, including intra-prediction and motion data, as well as residual data in the form of quantized transform coefficient data are all encoded in the bitstream. The final bitstream includes all information desired by the decoder to reconstruct the original partitioned video signal 201. Such information may also include intra-prediction mode index tables (also referred to as codeword mapping tables), definitions of encoding contexts for various blocks, indications of most probable intra-prediction modes, an indication of partition information, etc. Such data may be encoded be employing entropy coding. For example, the information may be encoded by employing context adaptive variable length coding (CAVLC), CABAC, syntax-based context-adaptive binary arithmetic coding (SBAC), probability interval partitioning entropy (PIPE) coding, or another entropy coding technique. Following the entropy coding, the coded bitstream may be transmitted to another device (e.g., a video decoder) or archived for later transmission or retrieval.

The present disclosure relates to deriving MVs at the decoder to describe non-continuous motion of encoded objects between frames without completely signaling such MVs from the encoder to the decoder in the bitstream. Hence, the motion vector derivation mechanisms described in the FIGS. below impact the operation of motion estimation component 221 and/or motion compensation component 219.

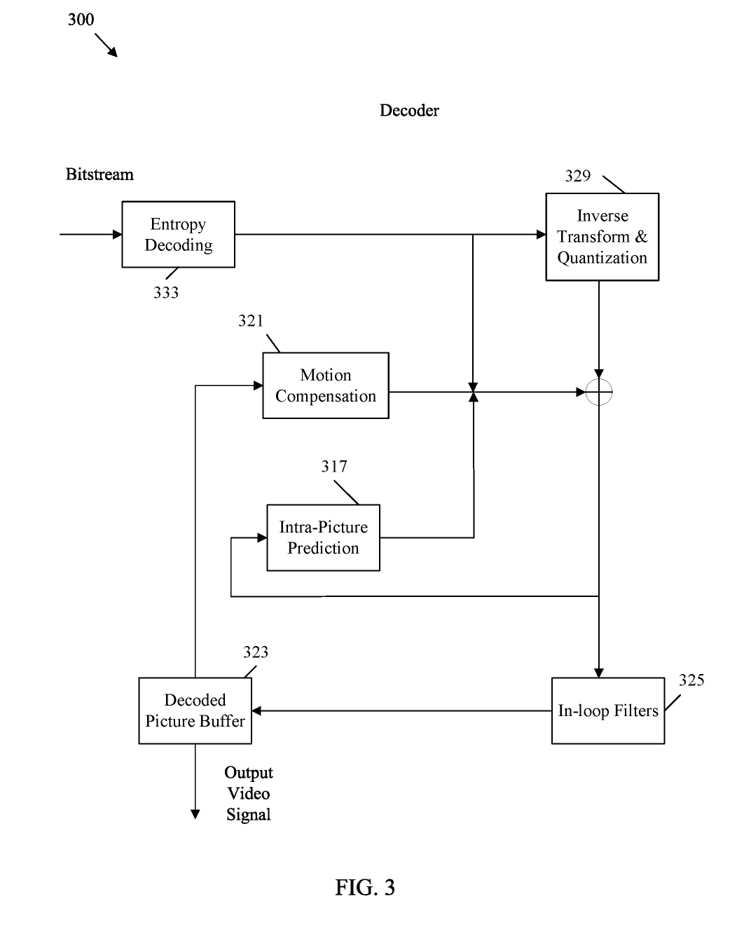

FIG. 3 is a block diagram illustrating an example video decoder 300 that may implement inter-prediction. Video decoder 300 may be employed to implement the decoding functions of codec system 200 and/or implement steps 111, 113, 115, and/or 117 of method 100. Decoder 300 receives a bitstream, for example from an encoder, and generates a reconstructed output video signal based on the bitstream for display to an end user.

The bitstream is received by an entropy decoding component 333. The entropy decoding component 333 is configured to implement an entropy decoding scheme, such as CAVLC, CABAC, SBAC, PIPE coding, or other entropy coding techniques. For example, the entropy decoding component 333 may employ header information to provide a context to interpret additional data encoded as codewords in the bitstream. The decoded information includes any desired information to decode the video signal, such as general control data, filter control data, partition information, motion data, prediction data, and quantized transform coefficients from residual blocks. The quantized transform coefficients are forwarded to an inverse transform and quantization component 329 for reconstruction into residual blocks. The inverse transform and quantization component 329 may be similar to inverse transform component 229.

The reconstructed residual blocks and/or prediction blocks are forwarded to intra-picture prediction component 317 for reconstruction into image blocks based on intra-prediction operations. The intra-picture prediction component 317 may be similar to intra-picture estimation component 215 and an intra-picture prediction component 217. Specifically, the intra-picture prediction component 317 employs prediction modes to locate a reference block in the frame and applies a residual block to the result to reconstruct intra-predicted image blocks. The reconstructed intra-predicted image blocks and/or the residual blocks and corresponding inter-prediction data are forwarded to a decoded picture buffer component 323 via in-loop filters component 325, which may be substantially similar to decoded picture buffer 223 and in-loop filters 225, respectively. The in-loop filters component 325 filters the reconstructed image blocks, residual blocks and/or prediction blocks, and such information is stored in the decoded picture buffer component 323. Reconstructed image blocks from decoded picture buffer component 323 are forwarded to a motion compensation component 321 for inter-prediction. The motion compensation component 321 may be substantially similar to motion estimation component 221 and/or motion compensation component 219. Specifically, the motion compensation component 321 employs motion vectors from a reference block to generate a prediction block and applies a residual block to the result to reconstruct an image block. The resulting reconstructed blocks may also be forwarded via the in-loop filters component 325 to the decoded picture buffer component 323. The decoded picture buffer component 323 continues to store additional reconstructed image blocks, which can be reconstructed into frames via the partition information. Such frames may also be placed in a sequence. The sequence is output toward a display as a reconstructed output video signal.

The present disclosure relates to deriving MVs at the decoder to describe non-continuous motion of encoded objects between frames without completely signaling such MVs from the encoder to the decoder in the bitstream. Hence, the motion vector derivation mechanisms described in the FIGS. below impact the operation of motion compensation component 321. Specifically, the mechanisms described below allow the motion compensation component 321 to derive MVs by obtaining reference frames from the decoded picture buffer component 323. The motion compensation component 321 can determine an MV between matching coding objects in the reference frames. The motion compensation component 321 can then position the coding object in intervening frames by employing the MV. The disclosed mechanisms allow the motion compensation component 321 to derive the MV even when motion is non-continuous between the reference frames.

In order to discuss determination of MVs in the non-continuous motion case, mechanisms for determining MVs in the continuous motion case are first described. A motion trajectory of an object is the object's movement over time. Movement of an object is depicted as a change in location of the object over successive frames. Motion trajectory is directional movement that can be described in terms of an MV. An MV includes a position offset that indicates a change in position of an object between a reference frame and a current frame being encoded/decoded using inter-prediction. The motion of the object is continuous when the offset changes at a constant rate between successive frames. The motion of the object is non-continuous when the offset changes at a rate that varies between successive frames. MVs can be encoded into the bitstream, but encoding all of the MVs can significantly increase the size of the encoding, and hence decrease coding efficiency.

Coding techniques such as advanced motion vector prediction (AMVP) and merge mode are mechanisms in HEVC that can be used to derive MVs. These techniques allow a decoder to determine certain MVs, and hence at least some of the MVs can be omitted from the bitstream. This in turn enhances inter-prediction efficiency and overall video compression efficiency. AMVP is a technique that constructs a list of candidate MVs based on motion vector predictors for adjacent blocks in the same frame and for temporally adjacent blocks in adjacent frames. Matching is then employed to select an MV. Merge mode signals a list of candidate MVs (and/or information sufficient to generate a list of candidate MVs at a decoder), along with index information to support selecting from the candidate list of MVs. Merge mode also allows MVs to be inherited from physically and temporally adjacent blocks. Accordingly, employing AMVP and merge mode allows some of the MVs for a frame to be omitted from the bitstream derived at a decoder. A pattern matched motion vector derivation (PMMVD) mode is a merge mode based on Frame-Rate Up Conversion (FRUC) techniques. FRUC techniques employ interpolation to generate frames in order to increase video frame rate. In PMMVD, an MV for a block is derived and refined at the decoder without any signaling from encoder side.

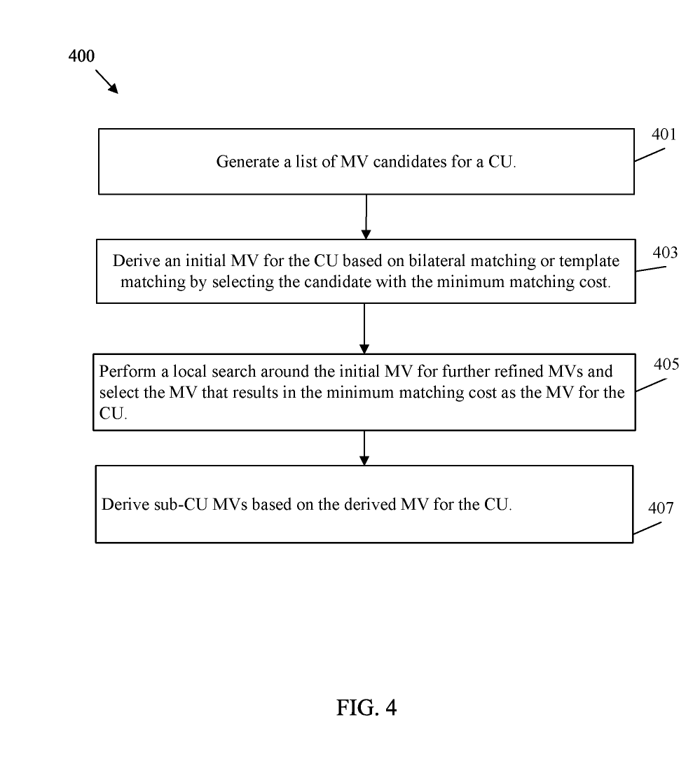

FIG. 4 is a flowchart of an example method 400 of deriving an MV for continuous motion trajectory in inter-prediction according to PMMVD. For example method 400 may be performed to determine MVs at block decoding step 113, motion estimation component 221, motion compensation component 219, and/or motion compensation component 321. To utilize a motion derivation process in FRUC merge mode, a CU-level motion search is performed, and then a sub-CU level motion refinement is performed.

At step 401, a list of MV candidates for a CU is generated, for example based on MVs from adjacent blocks, MVs for temporally adjacent blocks in other frames, zero motion vector candidates, and/or bi-predictive motion candidates. Such MVs can be signaled for corresponding blocks and/or be predicted based on motion vector predictors. However, the MVs may not be separately signaled for the current CU. When signaling occurs, such signaling may include indicating a horizontal and/or vertical change in coordinates between frames and/or indicating a change in horizontal and/or vertical coordinates relative to other signaled MVs.

At step 403 an initial MV is derived for the current CU based on bilateral matching or template matching, as discussed with respect to the FIGS below. Specifically, the blocks pointed to by the candidate MVs can be compared to a current block and/or a second reference block, depending on the example. The matching algorithm compares the values at the relevant blocks and expresses a difference as a matching cost. The candidate with the minimum matching cost is then selected as the initial MV. The initial MV is then employed as a starting point for further CU level refinement.

At step 405 a local search is performed around the initial MV. Further, MVs positioned at points inside a local search are also compared via the matching algorithm. This approach allows the MV to be refined, as the initial MV may not be the best match available in some cases. The MV in the search area that results in the minimum matching cost is then selected as the MV for the CU.

At step 407, the MV for the CU, as derived at step 405, is selected as an initial MV for the sub-CUs. A local search around the initial MVs for the sub-CUs can then be performed in a manner similar to step 405 and MVs with minimum matching costs can then be employed for the sub-CUs.

When an MV in steps 401-407 points to a fractional sample position, motion compensated interpolation can be employed to complete the sample for matching purposes. For example, bi-linear interpolation and/or eight-tap HEVC interpolation can be used for these purposes in bilateral matching 500 and/or template matching 600. Further, an MV refinement, as employed in steps 405 and 407 is a pattern based MV search with the criterion of bilateral matching cost or template matching cost. An unrestricted center-biased diamond search (UCBDS) and an adaptive cross search may be employed as search patterns for MV refinement at the CU level and sub-CU level, respectively. For both CU and sub-CU level MV refinement, the MV may be directly searched at quarter luma sample MV accuracy. MV refinement can then be searched at one-eighth luma sample accuracy. The search range of MV refinement for the CU and sub-CU may be set equal to eight luma samples.

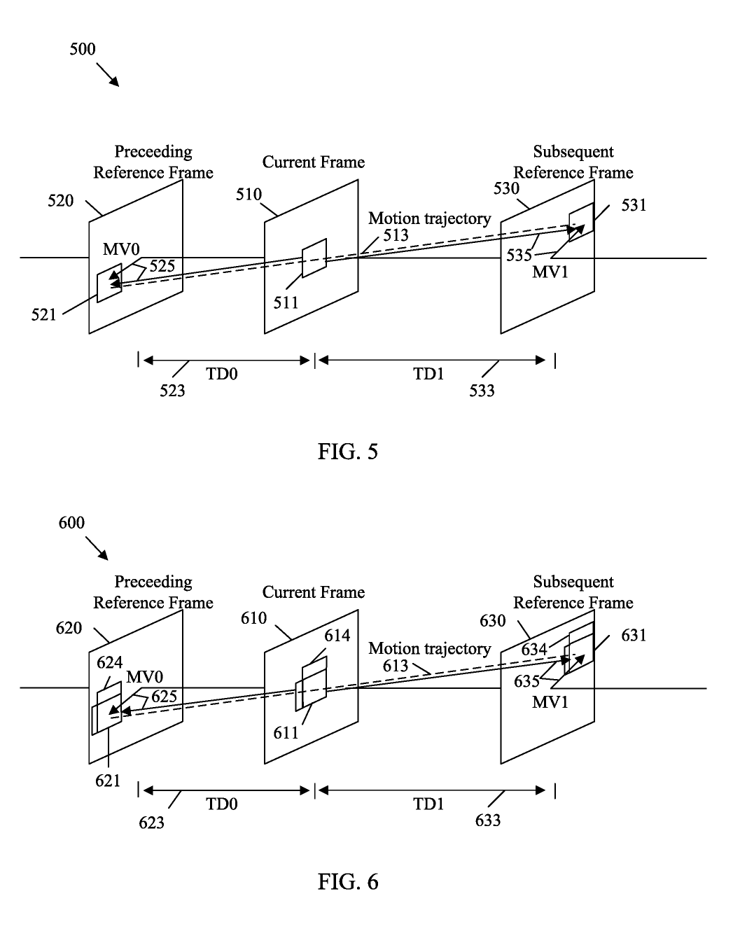

FIG. 5 is a schematic diagram illustrating an example of bilateral matching 500 in inter-prediction, for example as performed to determine MVs at block decoding step 113, motion estimation component 221, motion compensation component 219, and/or motion compensation component 321. Specifically, bilateral matching 500 can be employed to determine matching costs associated with an MV, and hence can be employed to select an initial MV from a candidate list, select a refined MV during a local search, and/or select MVs for sub-CUs as discussed in method 400.

As noted above a bitstream includes a plurality of encoded frames. Some of those coded frames can be designated as reference frames for inter-prediction. Bilateral matching 500 employs a first reference frame and a second reference frame, which are referred to herein as a preceding reference frame 520 and a subsequent reference frame 530 for clarity of discussion. Bilateral matching 500 is used to derive motion information of a current coding object 511 in a current frame 510 by finding a closest match between two blocks along a motion trajectory 513 of the current coding object in two different reference pictures.

A current frame 510 is a frame currently being decoded by a decoder. The preceding reference frame 520 is a reference frame that is positioned earlier in the video sequence than the current frame 510 and the subsequent reference frame 530 is a reference frame that is positioned later in the video sequence than the current frame 510. The current frame 510 may be interpolated from the preceding reference frame 520 and the subsequent reference frame 530, potentially along with other intervening frames, according to FRUC techniques. The coding object 511 is a related group of image data, such as a CTU, a CTB, a CU, and/or a sub-CU.

Bilateral matching 500 presumes that the coding object 511 is present and/or moving positions between frames. Accordingly, bilateral matching 500 determines a motion trajectory 513 between a preceding coding object 521 in the preceding reference frame 520 and a subsequent coding object 531 in the subsequent reference frame 530. The motion trajectory 513 is directional movement (e.g., up/down and left/right) of the coding object over time (e.g., between the frames). Presuming the motion trajectory 513 is continuous (e.g., at constant rate and direction between frames) an MV along the motion trajectory 513 between the preceding coding object 521 in the preceding reference frame 520 and the subsequent coding object 531 in the subsequent reference frame 530 can accurately position the coding object 511 in the current frame 510.

Accordingly, an MV at the same angle as the motion trajectory 513 is sub-divided into an MV0 525 pointing to the preceding coding object 521 and an MV1 535 pointing to the subsequent coding object 531. The current frame 510 is positioned some preceding temporal distance (TD0) 523 after the preceding reference frame 520 and some subsequent temporal difference (TD1) 533 before the subsequent frame 530. Temporal distance is measured in terms of time and/or intervening frames. Presuming continuous motion and a correct match, MV0 525 and MV1 535 have the same angle as the motion trajectory 513 and a length that is proportional to the relative temporal distances TD0 523 and TD1 533, respectively. As used in this context, an angle indicates a change in horizontal and/or vertical position relative to a temporal dimension. Hence MVs with the same angle change x coordinates and y coordinates at a constant rate over temporal distances TD0 523 and TD1 533, respectively.

Bilateral matching 500 employs the relationships shown in FIG. 5, as discussed above, to derive MV0 525 and MV1 535 based on a motion trajectory 513 defined according to a potential MV. Bilateral matching 500 then compares the coding object pointed to by MV0 525 (e.g., the preceding coding object 521) and the coding object pointed to by MV1 535 (e.g., the subsequent coding object 531). The comparison can be made by determining a SAD, a sum of absolute transformed difference (SATD), a mean square error (MSE), or other metrics for determining a difference between values of a coding object. A relatively small difference indicates that the preceding coding object 521 and the subsequent coding object 531 match and hence the motion trajectory 513 of the potential MV is correct. A relatively large difference indicates that the preceding coding object 521 and the subsequent coding object 531 do not match well, and hence the motion trajectory 513 of the potential MV is not correct. Hence, bilateral matching 500 may be employed on several potential MVs to determine which MV to select as an initial MV for a CU in step 403, determine which MV to select as a refined MV for a CU in step 405, and/or determine which MV to select for a sub-CU in step 407.

FIG. 6 is a schematic diagram illustrating an example of template matching 600 in inter-prediction, for example as performed to determine MVs at block decoding step 113, motion estimation component 221, motion compensation component 219, and/or motion compensation component 321. Specifically, bilateral matching 500 can be employed to determine matching costs associated with an MV, and hence can be employed to select an initial MV from a candidate list, select a refined MV during a local search, and/or select MVs for sub-CUs as discussed in method 400.

Template matching 600 includes a preceding reference frame 620 with a preceding coding object 621, a current frame 610 with a current coding object 611, and a subsequent reference frame 630 with a subsequent coding object 631, which are similar to preceding reference frame 520, preceding coding object 521, current frame 510, current coding object 511, subsequent reference frame 530, and subsequent coding object 531, respectively. The coding objects are correlated by a motion trajectory 613 that is described by an MV0 625 and an MV1 635 that are proportional to a TD0 623 and a TD 633, which are similar to motion trajectory 513, MV0 525, MV1 535, TD0 523, and TD1 533, respectively.

Template matching 600 is similar to bilateral matching 500, but can be performed between a current frame 610 and a preceding reference frame 620, a subsequent reference frame 630, or both. Hence, template matching 600 can be unidirectional (by matching between a current frame 610 and a preceding reference frame 620 or a subsequent reference frame 630) or bidirectional (by matching between a current frame 610 and both a preceding reference frame 620 and a subsequent reference frame 630). Further, template matching 600 matches templates instead of the coding objects. Specifically, a current coding object 611 is surrounded by a current template 614. The current template 614 includes blocks that are adjacent to the current coding object 611. The blocks may be positioned above and/or on the left side of the current coding object 611. The current template 614 can then be matched to a preceding template 624 adjacent to a preceding coding object 621 and/or to a subsequent template 634 adjacent to a subsequent coding object 631. Such matching can then be employed to determine a difference between the current template 614, the preceding template 624, and/or the subsequent template 634. Hence, template matching 600 may also be employed on several potential MVs to determine which MV to select as an initial MV for a CU in step 403, determine which MV to select as a refined MV for a CU in step 405, and/or determine which MV to select for a sub-CU in step 407.

As discussed above, method 400 can employ bilateral matching 500 and/or template matching 600 to derive an MV when a coding object's motion trajectory is continuous. When method 400 employs bilateral matching 500 merge mode, bi-prediction is applied, because the motion information of a coding object is derived based on the closest match between two coding objects along the motion trajectory of the current coding object in two different reference frames. There is no such limitation for the template matching 600 merge mode. In the template matching 600 merge mode, the encoder can choose among unidirectional prediction from an MV in a first candidate list (list0), unidirectional prediction from an MV in as second candidate list (list1), or bidirectional prediction for a coding object.

Regardless, of the matching mode employed by PMMVD, motion information may be derived at a decoder without signaling the MV in the bitstream by the encoder. The efficiency of this mode, as described in method 400, is based on the assumption that motion trajectory is continuous and smooth. This is because corresponding MVs are selected to employ the same angle as the motion trajectory, which is presumed to be continuous. The disclosure below contains modifications to PMMVD and method 400, which allow for derivation of the MVs even when the motion trajectory is non-continuous.

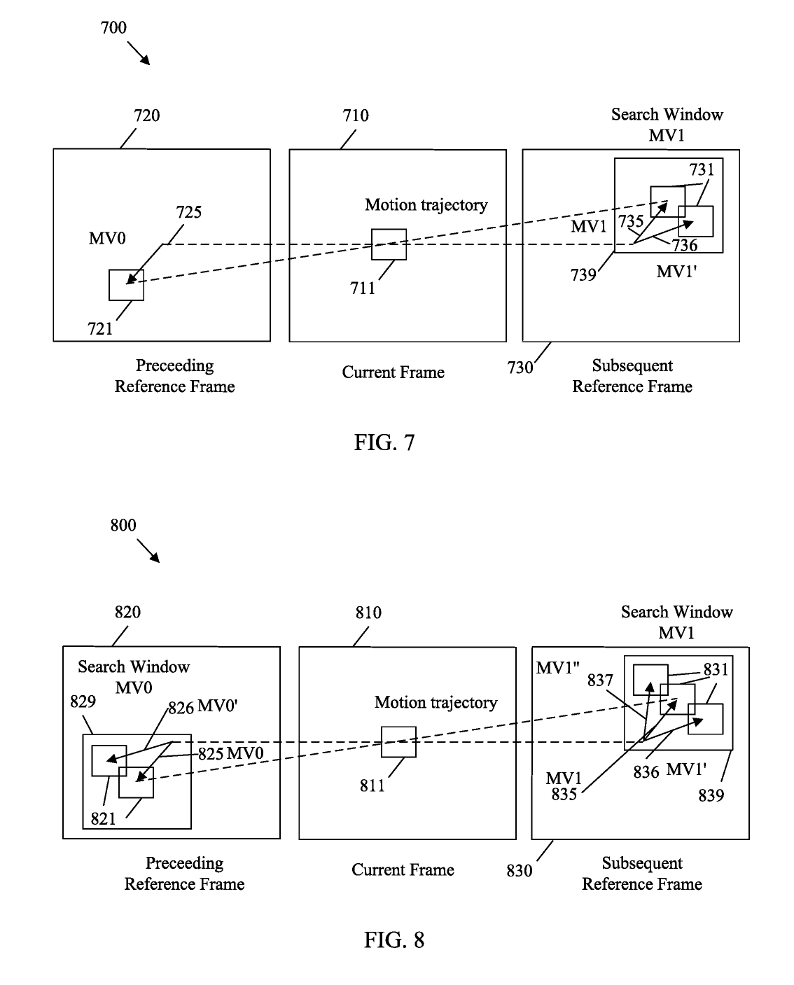

FIG. 7 is a schematic diagram illustrating an example mechanism 700 for deriving a non-continuous motion trajectory at a decoder by refining MV1. Mechanism 700 can be employed on MVs in steps 403, 405, and/or 407, in conjunction with bilateral matching 500 and/or template matching 600, to derive a non-continuous motion trajectory and select corresponding MVs from MV candidates even when such motion information is not signaled by the encoder in the bitstream. Hence, mechanism 700 can also be performed to determine MVs at block decoding step 113, motion estimation component 221, motion compensation component 219, and/or motion compensation component 321.

Mechanism 700 may receive an MV selected assuming a continuous motion trajectory between a preceding coding object 721 in a preceding reference frame 720, a current coding object 711 in a current frame 710, and a subsequent coding object 731 in a subsequent reference frame 730. Such items are similar to preceding coding object 521, preceding reference frame 520, current coding object 511, current frame 510, subsequent coding object 531, and subsequent reference frame 530, respectively.

Mechanism 700 derives a motion vector pair MV0 725 and MV1 735 at the decoder by allowing MV0 725 and MV1 735 to fall along different motion trajectories. Specifically, MV0 725 and MV1 735 are similar to MV0 525 and MV1 535, but the angle of one or both of MV0 725 and MV1 735 is changed to derive a non-continuous motion trajectory without direct signaling from the encoder in the bitstream.

For example, MV0 725 and MV1 735 are initially positioned along the same motion trajectory. A search window 739 is drawn around an area pointed to by MV1 735. For example, the search window 739 may be about three times taller and three times wider than the subsequent coding object 731. The search window 739 is drawn according to a set of predefined rules, and may take any desired shape such as a square, a rectangle, a circle, etc. Such rules are predefined in memory at both the encoder and the decoder. A set of refined subsequent motion vectors (MV1′) 736 pointing from the same origin as MV1 735 and pointing to predefined check points in the search window 739 are considered. MV1′ 736 includes MV1 735, and hence MV1′ 736 is equal to MV1 735 for the check point falling on the center of the search window 739. The vectors in MV1′ 736, other than MV1 735, have different angles than the initial motion trajectory.

The differences between the preceding coding object 721 pointed by MV0 725 and the subsequent coding objects 731 pointed by MV1′ 736 are calculated as matching costs, denoted as Cost(MV0, MV1′). The match costs can be determined according to bilateral matching 500 and/or template matching 600. Specifically, the match cost may be calculated and represented by a SAD, an SATD, an MSE, a SSD, or other metrics for difference comparisons. The MV1′ 736 with the smallest matching cost is then selected as an updated MV1 735. For example, when N check points are employed in the search window 739 around MV1 735, then N costs are obtained, e.g., Cost(MV0, MV1′1), Cost(MV0, MV1′2), . . . , Cost(MV0, MV1′N). These N costs are compared, and the MV1′ 736 (e.g., MV1′K) which yields the smallest matching cost is selected as the updated MV1 735. Accordingly, MV1 735 is updated, based on MV1′ 736, to match the subsequent coding objects 731 to the preceding coding object 721. When the motion of the coding object is non-continuous, the updated MV1 735 is at different angle than the MV0 725. This process can be completed repeatedly to find an updated MV1 735 for each of multiple MV0s 725.

When fractional sample positions are pointed to by MVs in mechanism 700 (e.g., due to the position of the search window 739) motion compensated interpolation, such as eight-tap HEVC interpolation, bi-linear interpolation, or other interpolation mechanisms can be employed to complete the sample for matching purposes.

Mechanism 700 can also be reversed by maintaining MV1 735 along the initial motion trajectory, drawing a search window 739 around an area pointed to by MV0 725, determining a set of refined preceding motion vectors (MV0′), and updating MV0 725 based on the MV0′ with the smallest matching cost with respect to MV1 735. This approach is a mathematical equivalent to the approach depicted in FIG. 7.

In one example, mechanism 700 can be employed when an initial MV is selected for a CU from a list of MV candidates at step 403 of method 400. For example, the MV candidates may point to an MV0 725 and an MV1 735 along the same motion trajectory. A set of MV1′ 736 are then checked in the search window 739. The MV1′ 736 which points to the reference block with the smallest matching cost with respect to the reference block pointed to by MV0 725 is used as the initial MV1 735.

In another example, mechanism 700 can be employed when a local search around the initial MV is performed at step 405. Accordingly, mechanism 700 may be employed after the initial motion vector is first selected for the CU from a list of MV candidates. In this case, the refined MVs may point to an MV0 725 and an MV1 735 along the same motion trajectory. A set of MV1′ 736 are then checked in the search window 739. The MV1′ 736 which points to the reference block with the smallest matching cost with respect to the reference block pointed to by MV0 725 is used as the refined MV1 735.

In yet another example mechanism 700 can be employed when sub-CU level MVs are derived based on CU motion vectors at step 407. For example, mechanism 700 may be employed after the refined motion vector selected for the CU. In this case, the multiple sub-CU MVs may point to an MV0 725 and an MV1 735 along the same motion trajectory. A set of MV1′ 736 are then checked in the search window 739. The MV1′ 736 which points to the reference block with the smallest matching cost with respect to the reference block pointed to by MV0 725 is used as the MV1 735 for the sub-CU.

FIG. 8 is a schematic diagram illustrating an example mechanism 800 for deriving a non-continuous motion trajectory at a decoder by refining an MV0 and MV1. Mechanism 800 can be employed on MVs in steps 403, 405, and/or 407, in conjunction with bilateral matching 500 and/or template matching 600, to derive a non-continuous motion trajectory and select corresponding MVs from MV candidates even when such motion information is not signaled by the encoder in the bitstream. Hence, mechanism 800 can also be performed to determine MVs at block decoding step 113, motion estimation component 221, motion compensation component 219, and/or motion compensation component 321.

Mechanism 800 is similar to mechanism 700. However, while mechanism 700 updates MV1 based on MV0, or vice versa, mechanism 800 iteratively updates MV1 based on MV0 and updates MV0 based on updated MV1. Mechanism 800 employs a current frame 810 with a current coding object 811 positioned between a preceding reference frame 820 with a preceding coding object 821 and a subsequent reference frame 830 with a subsequent coding object 831, which are similar to current frame 710, current coding object 711, preceding reference frame 720, preceding coding object 721, subsequent reference frame 730, and subsequent coding object 731, respectively.

Mechanism 800 derives a motion vector pair MV0 825 and MV1 835 at the decoder by allowing MV0 825 and MV1 835 to fall along different motion trajectories. Specifically, MV0 825 and MV1 835 are similar to MV0 525 and MV1 535, but the angle of one or both of MV0 825 and MV1 835 is changed to derive a non-continuous motion trajectory without direct signaling from the encoder in the bitstream.

For example, MV0 825 and MV1 835 are initially positioned along the same motion trajectory. A search window 839 is drawn around an area pointed to by MV1 835, in a manner substantially similar to search window 739 in mechanism 700. A set of MV1′ 836 pointing from the same origin as MV1 835 and pointing to predefined check points in the search window 839 are considered. The differences between the preceding coding object 821 pointed to by MV0 825 and the subsequent coding object 831 pointed by MV1′ 836 are calculated as matching costs as in mechanism 700. The MV1′ 836 with the lowest matching cost (e.g., smallest difference) can either be selected as an updated MV1 835 or maintained as a selected MV1′ 836 for further refinement.

In either case, a search window 829 can then be drawn around an area pointed to by MV0 825, in a manner substantially similar to search window 739 in mechanism 700. A set of MV0′ 826 pointing from the same origin as MV0 825 and pointing to predefined check points in the search window 829 are considered. The differences between the subsequent coding object 831 pointed to by the selected MV1′ 836 (or updated MV1 835) and the preceding coding objects 821 pointed by MV0′ 826 are calculated as matching costs as in mechanism 700. The MV0′ 826 with the lowest matching cost can then be selected as an updated MV0 825 or maintained as a selected MV0′ 826 for further refinement. When the selected MV0′ 826 and MV1′ 836 are selected as updated MV0 825 and MV1 835, respectively, the mechanism 800 is complete.

Otherwise, the mechanism 800 may further refine MV1′ 836 by drawing another search window 839 around the area pointed to by the selected MV1′ 836 (or employing the same search window 839 from a previous iteration). A set of MV1″ 837 pointing from the same origin as the selected MV1′ 836 and pointing to predefined check points in the search window 839 are considered. The differences between the preceding coding object 821 pointed to by the selected MV0′ 826 and the subsequent coding objects 831 pointed by MV1″ 837 are calculated as matching costs. The MV1″ 837 with the lowest matching cost (e.g., smallest difference) can either be selected as an updated MV1 835 or maintained as a selected MV1″ 837 for further refinement.

Accordingly, MV0 825 is updated based on MV1 835 (or vice versa), which is in turn refined by refined MV0 825. This process can continue for a predetermined number of iterations, until matching costs fall below a predetermined threshold, until matching costs fall below a predetermined threshold but not to exceed a predetermined number of iterations, etc. As such, when the motion of the coding object is non-continuous, the updated MV1 835 is at different angle than the MV0 825.

Mechanism 800 is an iterative extension of mechanism 700, and hence can be employed when an initial MV is selected for a CU from a list of MV candidates at step 403 of method 400, when a local search around the initial MV is performed at step 405, and/or when sub-CU level MVs are derived based on CU motion vectors at step 407 as in mechanism 700. Further, mechanism 800 can employ interpolation, such as eight-tap HEVC interpolation, bi-linear interpolation, or other interpolation mechanisms when fractional sample positions are implicated by the MVs. It should also be noted that mechanism 800 could refine MV0 825 before MV1 835, as such a process is a mathematical equivalent to the example shown in FIG. 8.

Mechanism 800 can be expressed in terms of matching cost functions as follows. For each MV0′ 826 (e.g., a check point within the MV0 search window 829), there is a corresponding MV1′ 836 along the same motion trajectory of MV0′ 826. A search window 839 is drawn around this MV1′ 836, and a set of check points in this MV1 window 839 are referred as MV1″ 837. The MV1″ 837 which points to the best matching reference block to the reference block that MV0′ 826 points to is used as refined MV1′ 836. This refined MV1′ 836 pairing with the MV0′ 826 are recorded as one pair of {MV0′, MV1′} of a group of candidates. Then MV0′ 826 moves to the next check point in MV0 refinement window 829. The same process repeats to find the next pair of {MV0′, MV1′ } candidates. After all check points in MV0 refinement window 829 are checked, assuming there are N check points in MV0 refinement window 829, N pairs of {MV0′, MV1′ } are obtained. Then the difference between reference blocks pointed by each pair of MV0′ 826 and MV1′ 836 is calculated, denoted as Cost(MV0′1, MV1′1), Cost(MV0′2, MV1′2), . . . , Cost(MV0′N, MV1′N). These N costs, Cost(MV0′1, MV1′1), Cost(MV0′2, MV1′2), . . . , Cost(MV0′N, MV1′N) are compared, and the pair (MV0′, MV1′) (e.g., MV0′K, MV1′K) which yields the smallest matching cost (e.g., Cost(MV0′K, MV1′K) is selected as the refined MV0 825 and MV1 835.

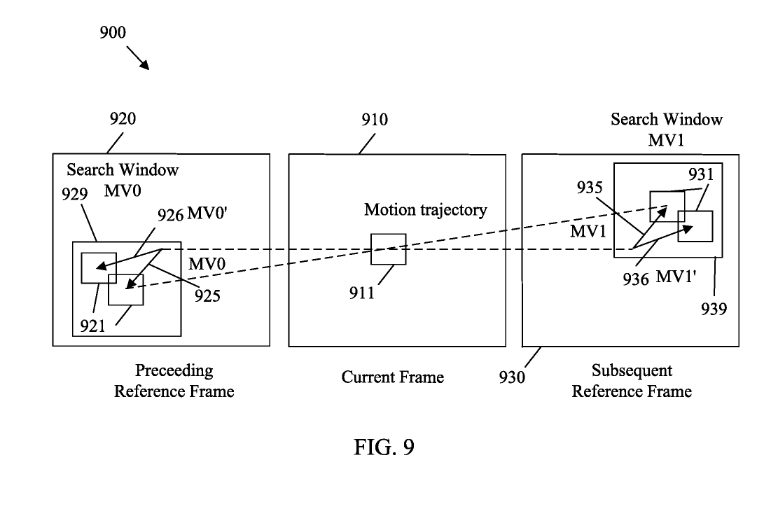

FIG. 9 is a schematic diagram illustrating an example mechanism 900 for deriving a non-continuous motion trajectory at a decoder by determining refined MV0 and MV1 pairs. Mechanism 900 can be employed on MVs in steps 403, 405, and/or 407, in conjunction with bilateral matching 500 and/or template matching 600, to derive a non-continuous motion trajectory and select corresponding MVs from MV candidates even when such motion information is not signaled by the encoder in the bitstream. Hence, mechanism 900 can also be performed to determine MVs at block decoding step 113, motion estimation component 221, motion compensation component 219, and/or motion compensation component 321.

Mechanism 900 is similar to mechanisms 700 and 800. However, mechanism 900 simultaneously determines an updated MV0 925 and MV1 935 pair based on an MV0′ 926 and MV1′ 936 instead of iterating as shown in mechanism 800. Mechanism 900 employs a current frame 910 with a current coding object 911 positioned between a preceding reference frame 920 with a preceding coding object 921 and a subsequent reference frame 930 with a subsequent coding object 931, which are similar to current frame 710, current coding object 711, preceding reference frame 720, preceding coding object 721, subsequent reference frame 730, and subsequent coding object 731, respectively.

Mechanism 900 derives a motion vector pair MV0 925 and MV1 935 at the decoder by allowing MV0 925 and MV1 935 to fall along different motion trajectories. Specifically, MV0 925 and MV1 935 are similar to MV0 525 and MV1 535, but the angle of one or both of MV0 925 and MV1 935 is changed to derive a non-continuous motion trajectory without direct signaling from the encoder in the bitstream.

For example, MV0 925 and MV1 935 are initially positioned along the same motion trajectory. A search window 939 is drawn around an area pointed to by MV1 935, in a manner substantially similar to search window 739 in mechanism 700. A set of MV1′ 936 pointing from the same origin as MV1 935 and pointing to predefined check points in the search window 939 are determined. Further, a search window 929 is drawn around an area pointed to by MV0 925, in a manner substantially similar to search window 739 in mechanism 700. A set of MV0′ 926 pointing from the same origin as MV0 925 and pointing to predefined check points in the search window 929 are also determined. Each MV0′ 926 is paired with each MV1′ 936, resulting in a two dimensional matrix of pairings, where the dimensions of the matrix are the number of MV0′ 926 and the number of MV1′ 936, respectively. A matching cost is then determined for the corresponding coding objects pointed to by each pair. The pair of MV0′ 926 and MV1′ 936 with the smallest matching cost is then selected as an updated MV0 925 and MV1 935 pair. As such, when the motion of the coding object is non-continuous, the updated MV1 935 is at different angle than updated the MV0 925.

Mechanism 900 is an iterative extension of mechanisms 700-800, and hence can be employed when an initial MV is selected for a CU from a list of MV candidates at step 403 of method 400, when a local search around the initial MV is performed at step 405, and/or when sub-CU level MVs are derived based on CU motion vectors at step 407 as in mechanisms 700-800. Further, mechanism 900 can employ interpolation, such as eight-tap HEVC interpolation, bi-linear interpolation, or other interpolation mechanisms when fractional sample positions are implicated by the MVs.

Mechanism 900 can be expressed in terms of matching cost functions as follows. A search window 929 is formed around MV0 925, denoted as W(MV0). Another search window 939 is formed around MV1 935, denoted as W(MV1). There are a total of M check points in W(MV0), denoted as MV0′1, MV0′2, . . . , MV0′M. Further, there are a total of N check points in W(MV1) denoted as MV1′1, MV1′2, . . . , MV1′N. The difference between each MV0′i 926 and MV1′j 936 is calculated, as denoted by Cost(MV0′i and MV1′j), where i and j are indexes for vectors in MV0′ 926 and MV1′ 936, respectively. The total M*N costs are compared, and the pair (MV0′, MV1′) (e.g., MV0′i, MV1′j) which yields the smallest matching cost (e.g., Cost(MV0′i, MV1′j) is selected as the refined MV0 925 and MV1 935.

As discussed above, the FRUC mechanism described in method 400 presumes that MV0 and MV1 are derived at the decoder without signaled information from the encoder. Accordingly, bilateral matching 500, template matching 600, and mechanisms 700, 800, and 900 are described in terms of deriving both MV0 and MV1. However, these methods/mechanisms can be modified to partially utilize signaled motion vector information together with decoder derived motion vector information to enhance bi-directional motion prediction efficiency.

In one example, one of the motion vectors, MV0 or MV1, employed in method 400 is derived by bilateral matching 500 and/or template matching 600, while the other motion vector is derived from a merge candidate list. Specifically, a merge candidate index can be signaled to indicate one of the MVs and the other MV can be derived. For example, when the motion vector information indicated by merge index has only one direction, the corresponding directional motion vector information is employed as the signaled MV. The motion vector information for the other direction is then decoder derived, for example by employing bilateral matching 500 and/or template matching 600 in conjunction with mechanism 700, 800, or 900. For example, the MV indicated by the merge candidate index is set as the updated MV (e.g., MV0). The other MV (e.g., MV1) is then derived by employing a search window and determining a least matching cost MV as the updated MV. When the motion vector information indicated by merge index is bi-directional, one flag (e.g. “merge_dir_idc”) may be signaled to indicate which direction uses the motion vector information indicated by the merge index and which direction is decoder derived (e.g., by FRUC). An example syntax for such partial signaling is shown in Table 1 below.

TABLE 1

| | |
|---|---|
| slice_segment_header( ) { | Descriptor |
| ... | |
| template_matching_mvd_enabled | ae(v) |
| ... | |
| } | |

A template_matching_mvd_enabled flag may be included in a slice header and may be set to one to indicate that, in the current slice, a bi-directional prediction coding unit includes signaled motion vector information for one direction while the motion vector information for the other direction is derived. The template_matching_mvd_enabled flag may be set to zero to indicate that, in the current slice, a bi-directional prediction coding unit has both directional motion vectors either signaled or derived. In another example, the template_matching_mvd_enabled flag may be signaled in a sequence parameter set (SPS) and/or picture parameter set (PPS) with same semantics, e.g., by replacing slice by sequence or picture in the above description.

Table 2 includes example syntax that can be employed to indicate which MV is signaled and which MV is derived by the decoder.

TABLE 2

| | |
|---|---|
| prediction_unit( x0, y0, nPbW, nPbH ) { | Descriptor |
| if( cu_skip_flag[ x0 ][ y0 ] ) { | |
| ... | |
| fruc_mode | ae(v) |
| ... | |
| if( MaxNumMergeCand > 1 ) | |
| merge_idx[ x0 ][ y0 ] | ae(v) |
| if( template_matching_mvd_enabled && slice_type = = B && fruc_mode ) | |
| merge_dir_idc[ x0 ][ y0 ] | ae(v) |
| } else { /* MODE_INTER */ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| fruc_mode | ae(v) |
| if( template_matching_mvd_enabled && slice_type = = B && fruc_mode ) | |
| merge_dir_idc[ x0 ][ y0 ] | ae(v) |
| } else { | |
| ... | |
| } | |
| } | |
| } | |

A fruc_mode flag can be set equal to one to indicate that a FRUC mode, such as method 400, is used to derive motion information for the current block. The fruc_mode flag can be set equal to zero to indicate that FRUC mode is not used to derive motion information for the current block. A merge_dir_idc[x0][y0] command can be employed to specify the direction (e.g., MV0 or MV1) that uses the motion information carried by in a merge candidate list as indicated by a merge candidate list index denoted by merge_idx. The other direction is derived from motion information (e.g., according to mechanism 700, 800, and/or 900).

In another example, for both merge list zero and merge list one, the corresponding motion information can be derived from template matching FRUC or calculated from the motion vector information signaled from encoder. For example, the MV can be signaled according to AMVP in HEVC or Advanced Video Coding (AVC). In general, a motion vector predictor (MVP) and associated motion vector difference (MVD) can be signaled to indicate one directional MV. The other directional MV can then be derived without signaling. An example syntax for such signaling is shown in Table 3 below.

TABLE 3

| | |
|---|---|
| prediction_unit( x0, y0, nPbW, nPbH ) { | Descriptor |
| if( cu_skip_flag[ x0 ][ y0 ] ) { | |
| if( MaxNumMergeCand > 1) | |
| merge_idx[ x0 ][ y0 ] | ae(v) |
| } else {/* MODE_INTER */ | |
| merge_flag[ x0 ][ y0 ] | ae(v) |
| if( merge_flag[ x0 ][ y0 ]) { | |
| if( MaxNumMergeCand > 1) | |
| merge_idx[ x0 ][ y0 ] | ae(v) |
| } else { | |
| if( slice_type = = B) | |
| inter_pred_idc[ x0 ][ y0 ] | ae(v) |
| if( inter_pred_idc[ x0 ][ y0 ] != PRED_L1 ) { | |
| template_matching_L0[ x0 ][ y0 ] | ae(v) |
| if( !template_matching_L0[ x0 ][ y0 ] ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| } | |
| if( inter_pred_idc[ x0 ][ y0 ] != PRED_L0 ) { | |
| if( ! template_matching_L0[ x0 ][ y0 ] ) | |
| template_matching_L1 [ x0 ][ y0 ] | ae(v) |
| if( !template_matching_L1 [ x0 ][ y0 ] ) { | |
| if( num_ref_idx_l1_active_minus1 > 0) | |
| ref_idx_l1 [ x0 ][ y0 ] | ae(v) |
| if( mvd_l1_zero_flag && inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |
| } | |

In Table 3, Template_matching_L0[x0][y0] can be set to one to specify that the motion information of list zero is derived by template matching FRUC. Template_matching_L0[x0][y0] can be set to zero to specify that the motion information of list zero is explicitly signaled. The array indices x0, y0 specify the location (x0, y0) of the top-left luma sample of the considered prediction block relative to the top-left luma sample of the picture. Further, Template_matching_L1[x0][y0] can be set to one to specify that the motion information of list one is derived by template matching FRUC. Template_matching_L1[x0][y0] can be set to zero to specify that the motion information of list one is explicitly signaled. The array indices x0, y0 specify the location (x0, y0) of the top-left luma sample of the considered prediction block relative to the top-left luma sample of the picture.

In another example, one of the bi-directional motion vectors MV0 and MV1 is derived by template matching FRUC, while the other is calculated from the motion vector information signaled from the encoder. One example of a motion vector signaling method is AMVP as in HEVC or AVC. In general, an MVP and associated MVD are signaled for a one directional MV. The other directional MV is derived without signaling. An example syntax is shown in Table 4 below where the flags and commands are as described with respect to Tables 1-3 above.

TABLE 4

| | |
|---|---|
| prediction_unit( x0, y0, nPbW, nPbH ) { | Descriptor |
| if( cu_skip_flag[ x0 ][ y0 ] ) { | |
| if( MaxNumMergeCand > 1 ) | |
| merge_idx[ x0 ][ y0 ] | ae(v) |
| } else { /* MODE_INTER */ | |
| merge_flag[ x0 ][ y0 ] | ae(v) |
| if( merge_flag[ x0 ][ y0 ]) { | |
| if( MaxNumMergeCand > 1 ) | |
| merge_idx[ x0 ][ y0 ] | ae(v) |
| } else { | |
| if( slice_type = = B ) | |
| inter_pred_idc[ x0 ][ y0 ] | ae(v) |
| if( inter_pred_idc[ x0 ][ y0 ] != PRED_L1 ) { | |
| if( inter_pred_idc[ x0 ][ y0 ] = = PRED_BI ) { | |
| template_matching_L0[ x0 ][ y0 ] | ae(v) |
| } | |
| if( !template_matching_L0[ x0 ][ y0 ] ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| } | |
| if( inter_pred_idc[ x0 ][ y0 ] != PRED_L0 ) { | |
| if( ! template_matching_L0[ x0 ][ y0 ] && inter_pred_idc[ x0 ][ y0 ] = = PRED_BI ) | |
| template_matching_L1[ x0 ][ y0 ] | ae(v) |
| if( !template_matching_L1[ x0 ][ y0 ] ) { | |
| if( num_ref_idx_l1_active_minus1 > 0 ) | |
| ref_idx_l1[ x0 ][ y0 ] | ae(v) |
| if( mvd_l1_zero_flag && inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |
| } | |

In another example, the syntax and parsing process are illustrated in Table 5, where the flags and commands are as described with respect to Tables 1-3 above.

TABLE 5

| | |
|---|---|
| prediction_unit( x0, y0, nPbW, nPbH ) { | Descriptor |
| if( cu_skip_flag[ x0 ][ y0 ] ) { | |
| if( MaxNumMergeCand > 1 ) | |
| merge_idx[ x0 ][ y0 ] | ae(v) |
| } else { /* MODE_INTER */ | |
| merge_flag[ x0 ][ y0 ] | ae(v) |
| if( merge_flag[ x0 ][ y0 ]) { | |
| if( MaxNumMergeCand > 1 ) | |
| merge_idx[ x0 ][ y0 ] | ae(v) |
| } else { | |
| if( slice_type = = B) | |
| inter_pred_idc[ x0 ][ y0 ] | ae(v) |
| if( inter_pred_idc[ x0 ][ y0 ] = = PRED_BI) { | |
| template_matching_L0[ x0 ][ y0 ] | ae(v) |
| if( ! template_matching_L0[ x0 ][ y0 ] ) | |
| template_matching_L1 [ x0 ][ y0 ] | ae(v) |
| } | |
| if( inter_pred_idc[ x0 ][ y0 ] != PRED_L1 ) { | |
| if( !template_matching_L0[ x0 ][ y0 ] ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp 10 flag[ x0 ][ y0 ] | ae(v) |
| } | |
| } | |
| if( inter_pred_idc[ x0 ][ y0 ] != PRED_L0 ) { | |
| if( !template_matching_L1 [ x0 ][ y0 ] ) { | |
| if( num_ref_idx_l1_active_minus1 > 0 ) | |
| ref_idx_l1 [ x0 ][ y0 ] | ae(v) |
| if( mvd_l1_zero_flag && inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |
| } | |

In another example, the MVD in reference list one can be parsed when the template_matching_L0[x0][y0] command is true. The syntax and parsing process are illustrated in Table 6 below, where the flags and commands are as described with respect to Tables 1-3 above.

TABLE 6

| | |
|---|---|
| prediction_unit( x0, y0, nPbW, nPbH ) { | Descriptor |
| if( cu_skip_flag[ x0 ][ y0 ] ) { | |
| if( MaxNumMergeCand > 1 ) | |
| merge_idx[ x0 ][ y0 ] | ae(v) |
| } else {/* MODE_INTER */ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else { | |
| if( slice_type = = B ) | |
| inter_pred_idc[ x0 ][ y0 ] | ae(v) |
| if( inter_pred_idc[ x0 ][ y0 ] = = PRED_BI ) { | |
| template_matching_L0[ x0 ][ y0 ] | ae(v) |
| if( ! template_matching_L0[ x0 ][ y0 ] ) | |
| template_matching_L1[ x0 ][ y0 ] | ae(v) |
| } | |
| if( inter_pred_idc[ x0 ][ y0 ] != PRED_L1 ) { | |
| if( !template_matching_L0[ x0 ][ y0 ] ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| } | |
| if( inter_pred_idc[ x0 ][ y0 ] != PRED_L0 ) { | |
| if( !template_matching_L1 [ x0 ][ y0 ] ) { | |
| if( num_ref_idx_l1_active_minus1 > 0 ) | |
| ref_idx_l1 [ x0 ][ y0 ] | ae(v) |
| if( mvd_l1_zero_flag && inter_pred_idc[ x0 ][ y0 ] = = PRED_BI && ! | |
| template_matching_L0[ x0 ][ y0 ]) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |
| } | |

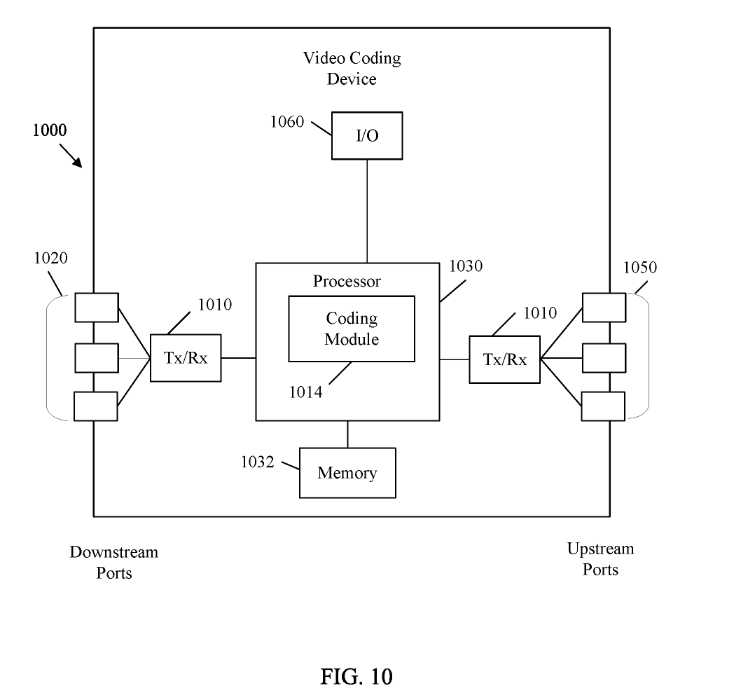

FIG. 10 is a schematic diagram of an example video coding device 1000 according to an embodiment of the disclosure. The video coding device 1000 is suitable for implementing the disclosed examples/embodiments as described herein. The video coding device 1000 comprises downstream ports 1020, upstream ports 1050, and/or transceiver units (Tx/Rx) 1010, including transmitters and/or receivers for communicating data upstream and/or downstream over a network. The video coding device 1000 also includes a processor 1030 including a logic unit and/or central processing unit (CPU) to process the data and a memory 1032 for storing the data. The video coding device 1000 may also comprise optical-to-electrical (OE) components, electrical-to-optical (EO) components, and/or wireless communication components coupled to the upstream ports 1050 and/or downstream ports 1020 for communication of data via optical or wireless communication networks. The video coding device 1000 may also include input and/or output (I/O) devices 1060 for communicating data to and from a user. The I/O devices 1060 may include output devices such as a display for displaying video data, speakers for outputting audio data, etc. The I/O devices 1060 may also include input devices, such as a keyboard, mouse, trackball, etc. and/or corresponding interfaces for interacting with such output devices.

The processor 1030 is implemented by hardware and software. The processor 1030 may be implemented as one or more CPU chips, cores (e.g., as a multi-core processor), field-programmable gate arrays (FPGAs), application specific integrated circuits (ASICs), and digital signal processors (DSPs). The processor 1030 is in communication with the downstream ports 1020, Tx/Rx 1010, upstream ports 1050, and memory 1032. The processor 1030 comprises a coding module 1014. The coding module 1014 implements the disclosed embodiments described above, such as methods 100, 400, 1100 and/or 1200, mechanisms 700, 800, and/or 900, bilateral matching 500, template matching 600, and/or any other method/mechanism described herein. Further, the coding module 1014 may implement a codec system 200 and/or a decoder 300. Accordingly, coding module 1014 can be employed to employ bilateral matching 500 and/or template matching 600 in conjunction with mechanisms 700, 800, and/or 900 to determine an MV1 and/or an MV2 for use in FRUC method 400 when a motion trajectory of a coding object is non-continuous. Coding module 1014 can also be employed to determine when one of the MVs is signaled as an index into a merge candidate list, determine the signaled MV, and derive the other MV based on the signaled MV. The inclusion of the coding module 1014 therefore provides a substantial improvement to the functionality of the video coding device 1000, by allowing the decoder to decode a bitstream with fewer signaled MVs and hence allowing for a more efficient encoding. Further, coding module 1014 effects a transformation of the video coding device 1000 to a different state. Alternatively, the coding module 1014 can be implemented as instructions stored in the memory 1032 and executed by the processor 1030 (e.g., as a computer program product stored on a non-transitory medium).

The memory 1032 comprises one or more memory types such as disks, tape drives, solid-state drives, read only memory (ROM), random access memory (RAM), flash memory, ternary content-addressable memory (TCAM), static random-access memory (SRAM), etc. The memory 1032 may be used as an over-flow data storage device, to store programs when such programs are selected for execution, and to store instructions and data that are read during program execution.

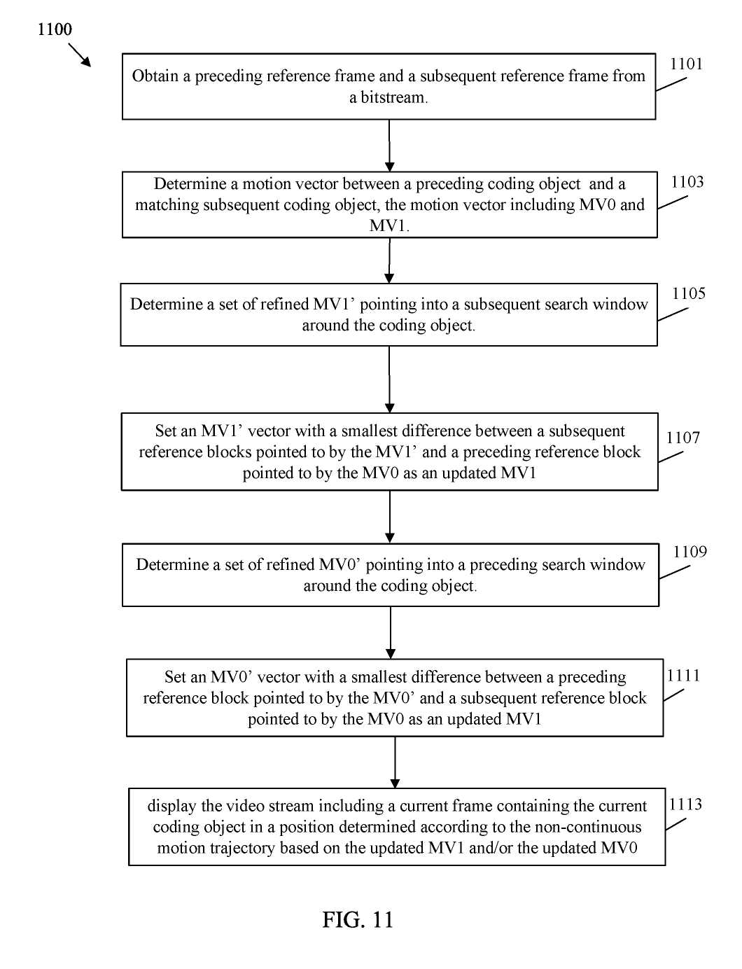

FIG. 11 is a flowchart of an example method 1100 of video decoding by deriving a non-continuous motion trajectory at a decoder by refining MV0 and/or MV1. For example, method 1100 can be employed to implement mechanisms 700 and/or 800 for use in conjunction with method 400, bilateral matching 500, and/or template matching 600 when implementing inter-prediction according to method 100. Further, method 1100 can be implemented by a video coding device 1000 as part of operating a codec system 200 and/or a decoder 300.

At step 1101, a plurality of reference frames are obtained from a bitstream. The reference frames include a preceding reference frame and a subsequent reference frame. The preceding reference frame and the subsequent reference frame are positioned before and after a current frame in a video sequence. The current frame can then be generated based on the preceding reference frame and the subsequent reference frame according to a FRUC method, such as method 400.

At step 1103, a motion vector is determined between a preceding coding object in the preceding reference frame and a matching subsequent coding object in the subsequent reference frame. The motion vector includes an MV0 between the current frame and the preceding reference frame. The motion vector also includes an MV1 between the current frame and the subsequent reference frame. Hence MV0 points in the opposite direction from MV1. In one example, the motion vector including MV1 and MV0 can be selected from a list of continuous motion trajectory candidate vectors generated when determining an initial motion vector to position a CU in the current frame based on bilateral matching or template matching, for example as part of step 403 in method 400. In another example, the motion vector that includes MV1 and MV0 can be selected as part of a local search during refinement of an initial motion vector to position the CU in the current frame based on bilateral matching or template matching, for example as part of step 405 in method 400. In yet another example, the motion vector that includes MV1 and MV0 can be selected as part of a sub-CU refinement based on an initial motion vector to position the CU in the current frame, for example as part of step 407 in method 400.

Regardless of the example, the motion vector determined by step 1103 indicates a continuous motion trajectory. The remaining steps of method 1100 can be employed to determine a non-continuous motion trajectory associated with a current coding object moving between the preceding coding object and the subsequent coding object. Accordingly, at step 1105, a subsequent search window is set to encompass an area of the subsequent reference frame pointed to by MV1. For example, the subsequent search window may encompass the subsequent coding object. A set of MV1′ pointing into the subsequent search window are then determined, for example by checking predetermined points in the subsequent search window.

At step 1107, differences are determined between subsequent reference block(s) pointed to by the MV1′ and a preceding reference block pointed to by the MV0. Such differences can be determined according to a SAD, an SAID, an MSE, or combinations thereof Δn MV1′ vector with a smallest difference is set as an updated MV1. In cases where MV1′ points to a partial sample, bilinear interpolation and/or eight-tap HEVC interpolation can be employed to interpolate the sample to support determining the differences. Steps 1105 and 1107 derive an updated MV1 based on an MV0, and the updated MV1 contains a different angle than MV0 when the motion trajectory of the coding object is non-continuous.

At step 1109, a preceding search window is set to encompass an area of the preceding reference frame pointed to by MV0. For example, the preceding search window may encompass the preceding coding object. A set of MV0′ pointing into the preceding search window are then determined, for example by checking predetermined points in the preceding search window.

At step 1111, differences are determined between preceding reference block(s) pointed to by the MV0′ and a subsequent reference block pointed to by MV1. Such differences can be determined according to a SAD, an SAID, an MSE, or combinations thereof Δn MV0′ vector with a smallest difference is set as an updated MV0. In cases where MV0′ points to a partial sample, bilinear interpolation and/or eight-tap HEVC interpolation can be employed to interpolate the sample to support determining the differences. Steps 1109 and 1111 derive an updated MV0 based on an MV1, and the updated MV0 contains a different angle than MV1 when the motion trajectory of the coding object is non-continuous.

In some examples, steps 1105 and 1107 are omitted so that an MV0 is updated based on an MV1. In some cases, this may occur when MV1 is determined from a merge candidate list signaled in the bitstream, for example as a merge list index, an MVP, an MVD, or combinations thereof. In other examples, steps 1109 and 1111 are omitted so that an MV1 is updated based on an MV0. In some cases, this may occur when MV0 is determined from a merge candidate list signaled in the bitstream, for example as a merge list index, an MVP, an MVD, or combinations thereof. In still other examples, steps 1109 and 1111 are applied before steps 1105 and 1107. In yet other examples, steps 1105 and 1107 and steps 1109 and 1111 are applied repeatedly so that MV0 and MV1 can be iteratively updated based on each other. Any of the above examples may also occur when the non-continuous motion trajectory is not signaled in the bitstream.

Regardless of the example, the derived MVs can be employed to place the coding object in the current frame according to a FRUC method, such as method 400, as part of inter-prediction. At step 1113, a video stream is generated for display on a display screen, for example based on inter-prediction employing FRUC. The generated video stream includes the current frame that contains the current coding object, which is placed in a position determined according to the non-continuous motion trajectory based on the updated MV1 and the MV0.

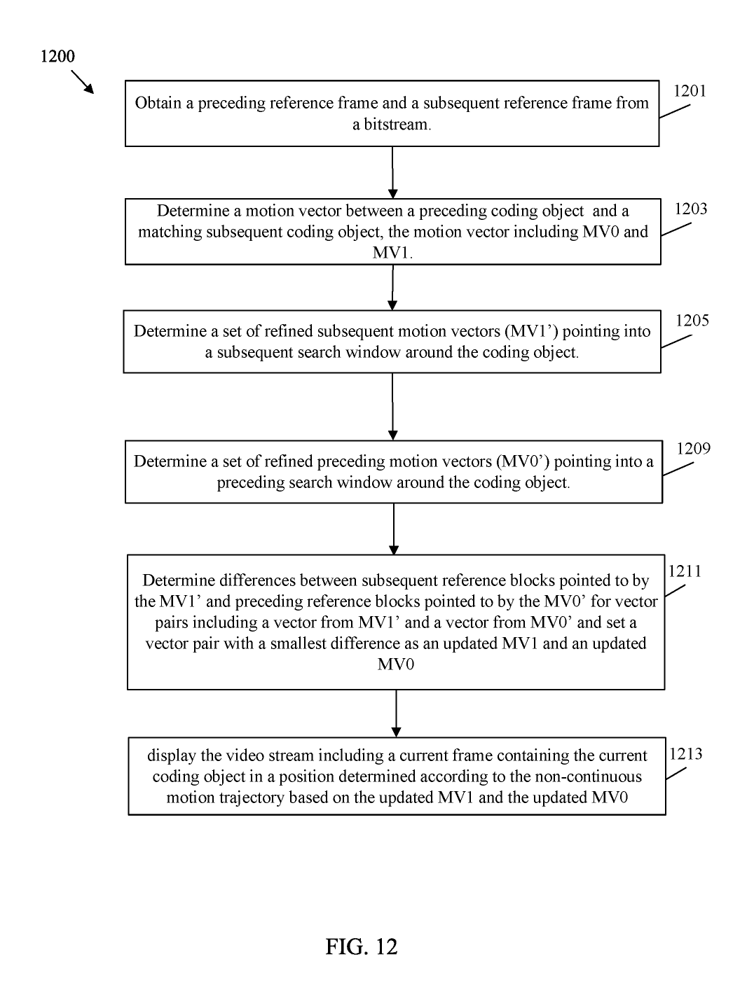

FIG. 12 is a flowchart of an example method 1200 of video decoding by deriving a non-continuous motion trajectory at a decoder by determining refined MV0 and MV1 pairs. For example, method 1200 can be employed to implement mechanism 900 for use in conjunction with method 400, bilateral matching 500, and/or template matching 600 when implementing inter-prediction according to method 100. Further, method 1200 can be implemented by a video coding device 1000 as part of operating a codec system 200 and/or a decoder 300.

Steps 1201, 1203, 1205, 1209, and 1213 are substantially similar to steps 1101, 1103, 1105, 1109, and 1113 as discussed above. Step 1211 is different from steps 1107 and 1109 because step 1211 determines an updated MV0 and an updated MV1 as part of a single computation instead of an iterative computation. Specifically, step 1211 determines a matrix of differences between subsequent reference blocks pointed to by the MV1′ vectors and preceding reference blocks pointed to by the MV0′ vectors. Hence, the matrix includes differences for each vector pair that includes a vector from MV1′ and a vector from MV0′. The vector pair with a smallest difference is then set as an updated MV1 and an updated MV0. Accordingly, steps 1205, 1209, and 1211 derive an updated MV1 based on an MV0 and an updated MV0 based on MV1. The updated MV1 contains a different angle than the updated MV0 when the motion trajectory of the coding object is non-continuous. The updated vector pairs can then be employed to position the coding object in the current frame for display in a video stream according to step 1213.

Method 1200 can be employed to derive a non-continuous motion trajectory when such non-continuous motion trajectory is not signaled in the bitstream. However, method 1200 could also be employed when MV1 or MV0 is signaled in a merge list. In such a case, the side of the matrix for the signaled MV is reduced to a single element that includes the signaled MV. Such a scenario effectively reduces mechanism 900 to mechanism 700 from a mathematical standpoint.

The disclosure includes a video decoder comprising: a receiving means to receive a bitstream; a processing means to generate a plurality of reference frames from the bitstream, the reference frames including a preceding reference frame and a subsequent reference frame; determine a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; determine a non-continuous motion trajectory of a current coding object between the preceding coding object and the subsequent coding object by: setting a subsequent search window to encompass an area of the subsequent reference frame pointed to by MV1, determining a set of refined subsequent motion vectors (MV1′) pointing into the subsequent search window, determining differences between subsequent reference blocks pointed to by the MV1′ and a preceding reference block pointed to by the MV0, and setting an MV1′ vector with a smallest difference as an updated MV1; and generate a video stream for display on a display means, the video stream including a current frame, the current frame containing the current coding object in a position determined according to the non-continuous motion trajectory based on the updated MV1 and the MV0.

The disclosure also includes a video decoder comprising: a receiving means for receiving a bitstream; and a processing means for generating a plurality of reference frames from a bitstream, the reference frames including a preceding reference frame and a subsequent reference frame; determining a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; determining a non-continuous motion trajectory of a current coding object between the preceding coding object and the subsequent coding object by: setting a preceding search window to encompass an area of the preceding reference frame pointed to by MV0, determining a set of refined preceding motion vectors (MV0′) pointing into the preceding search window, determining differences between preceding reference blocks pointed to by the MV0′ and a subsequent reference block pointed to by the MV1, and setting an MV0′ vector with a smallest difference as an updated MV0; and generating a video stream for display on a display means, the video stream including a current frame, the current frame containing the current coding object in a position determined according to the non-continuous motion trajectory based on the updated MV0 and the MV1.

The disclosure also includes a video coding device comprising: a receiving means configured to receive a bitstream including a plurality of coded reference frames, the reference frames including a preceding reference frame and a subsequent reference frame; and a processing means configured to: determine a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; determine a non-continuous motion trajectory of a current coding object between the preceding coding object and the subsequent coding object by: setting a subsequent search window to encompass an area of the subsequent reference frame pointed to by MV1, determining a set of refined subsequent motion vectors (MV1′) pointing into the subsequent search window, setting a preceding search window to encompass an area of the preceding reference frame pointed to by MV0, determining a set of refined preceding motion vectors (MV0′) pointing into the preceding search window, determining differences between subsequent reference blocks pointed to by the MV1′ and preceding reference blocks pointed to by the MV0′ for vector pairs including a vector from MV1′ and a vector from MV0′, and setting a vector pair with a smallest difference as an updated MV1 and an updated MV0; and generate a video stream for display on a display screen, the video stream including a current frame, the current frame containing the current coding object in a position determined according to the non-continuous motion trajectory based on the updated MV1 and the updated MV0.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented in a video decoder, the method comprising:
generating, by a processor in the video decoder, a plurality of reference frames from a bitstream, the reference frames including a preceding reference frame and a subsequent reference frame;
determining, by the processor, a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; and
determining, by the processor, a non-continuous motion trajectory of a current coding object between the preceding coding object and the subsequent coding object by:
setting a subsequent search window to encompass an area of the subsequent reference frame pointed to by MV1,
determining a set of refined subsequent motion vectors (MV1′) pointing into the subsequent search window,
determining differences between subsequent reference blocks pointed to by the MV1′ and a preceding reference block pointed to by the MV0, and
setting an MV1′ vector with a smallest difference as an updated MV1.

2. The method of claim 1, wherein the non-continuous motion trajectory is not signaled in the bitstream.

3. The method of claim 1, wherein the differences are determined according to a sum of absolute differences (SAD), a sum of absolute transformed difference (SAID), a mean square error (MSE), or combinations thereof.

4. The method of claim 1, wherein determining the non-continuous motion trajectory of the current coding object further includes:
setting a preceding search window to encompass an area of the preceding reference frame pointed to by MV0,
determining a set of refined preceding motion vectors (MV0′) pointing into the preceding search window,
determining differences between preceding reference blocks pointed to by MV0′ and a subsequent reference block pointed to by the updated MV1,
setting an MV0′ vector with a smallest difference as an updated MV0, and
wherein non-continuous motion trajectory is further determined based on the updated MV0.

5. The method of claim 1, wherein the motion vector including MV1 and MV0 is selected from a list of continuous motion trajectory candidate vectors generated when determining an initial motion vector to position a coding unit (CU) based on bilateral matching or template matching.

6. The method of claim 1, wherein the motion vector including MV1 and MV0 is selected as part of a local search during refinement of an initial motion vector to position a coding unit (CU) based on bilateral matching or template matching.

7. The method of claim 1, wherein the motion vector including MV1 and MV0 is selected as part of a sub-coding unit (CU) refinement based on an initial motion vector to position a coding unit (CU).

8. The method of claim 1, wherein the differences between the subsequent reference blocks pointed to by the MV1′ and the preceding reference block pointed to by the MV0 are further determined according to bilinear interpolation or eight-tap High Efficiency Video Coding (HEVC) interpolation.

9. The method of claim 1, wherein MV0 is determined from a merge candidate list signaled in the bitstream.

10. The method of claim 1, wherein MV0 is signaled in the bitstream as a motion vector predictor (MVP) and an associated motion vector difference (MVD).

11. A method implemented in a video decoder, the method comprising:
generating, by a processor in the video decoder, a plurality of reference frames from a bitstream, the reference frames including a preceding reference frame and a subsequent reference frame;
determining, by the processor, a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; and
determining, by the processor, a non-continuous motion trajectory of a current coding object between the preceding coding object and the subsequent coding object by:
setting a preceding search window to encompass an area of the preceding reference frame pointed to by MV0,
determining a set of refined preceding motion vectors (MV0′) pointing into the preceding search window,
determining differences between preceding reference blocks pointed to by the MV0′ and a subsequent reference block pointed to by the MV1, and
setting an MV0′ vector with a smallest difference as an updated MV0.

12. The method of claim 11, wherein the motion vector including MV1 and MV0 is selected from a list of continuous motion trajectory candidate vectors generated when determining an initial motion vector to position a coding unit (CU) based on bilateral matching or template matching.

13. The method of claim 11, wherein the motion vector including MV1 and MV0 is selected as part of a local search during refinement of an initial motion vector to position a coding unit (CU) based on bilateral matching or template matching.

14. The method of claim 11, wherein the motion vector including MV1 and MV0 is selected as part of a sub-coding unit (CU) refinement based on an initial motion vector to position a coding unit (CU).

15. The method of claim 11, wherein MV1 is determined from a merge candidate list signaled in the bitstream.

16. A video coding device comprising:
a receiver configured to receive a bitstream including a plurality of coded reference frames, the reference frames including a preceding reference frame and a subsequent reference frame;
a processor coupled to the receiver, the processor configured to:
determine a motion vector between a preceding coding object in the preceding reference frame and a matching subsequent coding object in the subsequent reference frame, the motion vector including a preceding motion vector (MV0) between a current frame and the preceding reference frame and a subsequent motion vector (MV1) between the current frame and the subsequent reference frame; and
determine a non-continuous motion trajectory of a current coding object between the preceding coding object and the subsequent coding object by:
setting a subsequent search window to encompass an area of the subsequent reference frame pointed to by MV1,
determining a set of refined subsequent motion vectors (MV1′) pointing into the subsequent search window,
setting a preceding search window to encompass an area of the preceding reference frame pointed to by MV0,
determining a set of refined preceding motion vectors (MV0′) pointing into the preceding search window,
determining differences between subsequent reference blocks pointed to by the MV1′ and preceding reference blocks pointed to by the MV0′ for vector pairs including a vector from MV1′ and a vector from MV0′, and
setting a vector pair with a smallest difference as an updated MV1 and an updated MV0.

17. The video coding device of claim 16, wherein the non-continuous motion trajectory is not signaled in the bitstream.

18. The video coding device of claim 16, wherein the motion vector including MV1 and MV0 is selected from a list of continuous motion trajectory candidate vectors generated when determining an initial motion vector to position a coding unit (CU) based on bilateral matching or template matching.

19. The video coding device of claim 16, wherein the motion vector including MV1 and MV0 is selected as part of a local search during refinement of an initial motion vector to position a coding unit (CU) based on bilateral matching or template matching.

20. The video coding device of claim 16, wherein the motion vector including MV1 and MV0 is selected as part of a sub-coding unit (CU) refinement based on an initial motion vector to position a coding unit (CU).
